(19) United States
(12) Patent Application Publication
(10) Pub. No.: US 2023/0215592 A1
(43) Pub. Date: Jul. 6, 2023

(54) GRAPHITE DECONTAMINATION

(71) Applicant: THE UNIVERSITY OF MANCHESTER, MANCHESTER (GB)

(72) Inventors: Tatiana GREBENNIKOVA, Manchester (GB); Clint Alan SHARRAD, Manchester (GB); Abbie Nadia JONES, Manchester (GB)

(21) Appl. No.: 18/000,855

(22) PCT Filed: Jun. 10, 2021
(86) PCT No.: PCT/GB2021/051445

§ 371 Date: Dec. 6, 2022

(30) Foreign Application Priority Data
Jun. 10, 2020 (GB) 2008809.2

(51) Int. Cl. G21F 9/00; G21F 9/30

(52) U.S. Cl. CPC G21F 9/002; G21F 9/30

(57) ABSTRACT

The present invention relates to methods of decontaminating irradiated nuclear graphite. The method comprises immersing the irradiated nuclear graphite in a molten salt electrolyte, and subjecting the irradiated nuclear graphite to an electrochemical treatment.

The present invention relates to methods of decontaminating irradiated nuclear graphite.

### BACKGROUND

Graphite has been used as a moderator and reflector material in more than 100 nuclear power plants worldwide as well as in reactors specially designed to produce plutonium [1]. The irradiated graphite waste stream that arises from the use of these power plants has presented a significant and complex decommissioning issue due to radiolytic oxidation of the graphite, activation of impurities in the material and the contamination of graphite with corrosion and fission products [2]. Variable compositions of long-lived (e.g. ¹⁴C, ³⁶Cl) and short-lived (e.g. ³H and ⁶⁰Co) isotopes have created substantial difficulties in managing nuclear graphite waste [3].

After the operation of gas-cooled and Magnox nuclear reactors, the UK has approximately 96,000 tonnes of nuclear graphite [4] and over 300,000 tonnes worldwide for which there is no clear disposal route. Therefore, identifying credible, economic and efficient approaches to managing nuclear graphite after its use in reactor systems is of crucial importance to the UK and to other countries that, both currently and/or in the future, possess such graphite bearing waste [5].

The current position of the UK Nuclear Decommissioning Authority (NDA) is to provide a temporary storage facility for irradiated graphite waste to allow the activity of short-lived isotopes to sufficiently decay before final disposal [6]. However, due to the presence of the long-lived isotopes, the long term waste strategy waste is for graphite to reside in the UK’s higher activity waste deep geological disposal facility (GDF), once commissioned. In such a facility, however, graphite could potentially occupy over 150000 m³ of storage capacity. [7].

The treatment of irradiated graphite prior to final disposal can offer a significant decrease in the activity and potential volume of waste requiring GDF storage, thus reducing the GDF footprint resulting in significant financial savings in interim storage and final disposal costs. The significant challenge to overcome is the variability of possible radioactive contamination present in irradiated graphite, as well as their distribution which depends on the origin and grade of graphite.

One of the standard treatment methods considered for volume reduction of waste nuclear graphite is thermal treatment via oxidation [8-15]. The typical oxidation method proposed for irradiated graphite is based on gasification of graphite at elevated temperatures (above 600° C.) with limited oxygen presence (around 1%) or steam as a mild oxidising agent [24-30]. However, the secondary waste created during these processes proves to be problematic, and methods used to manage this secondary waste would require specific regulatory approval [16-20]. Several recent studies have focused on a preferable release of ¹⁴C and ³H from the irradiated graphite without significant degradation of the material reporting no more than 3% for ³H and less than 1% for ¹⁴C to have been removed from the graphite samples tested [21-27].

Another challenge is associated with corrosion and fission products, and actinide contaminated graphite, which can be found in significant quantities due to fuel failure or other accidental releases [28,29]. Currently, there is no explicit option for treatment and management of this waste stream. Studies conducted by Vulpius et al. [20] on neutron-irradiated graphite showed electrolysis of this graphite in aqueous media gave significant transfer of the majority of the contaminant fission products to the acidic electrolyte solutions. However, little removal of the ⁶⁰Co contaminant was observed. Tian et al. [30] studied the use of reactor-grade graphite spheres as an anode material in different acid and salt electrolytes, reporting that the salt system was advantageous for the disintegration of the graphite.

Recent studies conducted at the University of Manchester have explored the impact of electrochemical treatment on irradiated nuclear graphite in a molten salt medium, reporting a total activity reduction up to 60% for ⁶⁰Co contaminant (gamma emitter) under a single fixed potential for the duration of the treatment [31].

The present invention provides a method of decontaminating irradiated nuclear graphite to address the above issues. The present invention provides the simultaneous removal of multiple contaminants (such as gamma emitters including ⁶⁰Co, ¹³³Ba, ¹³⁷Cs, ¹⁵⁴Eu and beta emitters including ³H and ¹⁴C) from irradiated nuclear graphite using temperatures (e.g. 450° C.) lower than those studied for gasification treatment methods (600° C. and higher).

### SUMMARY OF THE INVENTION

In a first aspect of the invention there is provided a method of electrochemically decontaminating irradiated nuclear graphite, the method comprising:
immersing irradiated nuclear graphite in a molten salt electrolyte, wherein the molten salt comprises one or more alkali metal halide salts, alkaline earth metal halide salts, or combinations thereof; and
subjecting the irradiated nuclear graphite to an electrochemical treatment comprising one or more electrochemical cycles, wherein each electrochemical cycle comprises exposing the irradiated nuclear graphite to an oxidising and reducing electric potential.

The irradiated nuclear graphite is exposed to oxidising and reducing electrical potentials. The irradiated nuclear graphite will be exposed to a current whereby the oxidising and reducing potentials are switched from one state to the other, hereafter referred to as an electrochemical cycle, i.e. each electrochemical cycle will comprise of a switch between electropositive and electronegative potentials or vice versa.

As will be understood by those skilled in the art, the oxidising and reducing potentials may suitably be measured with respect a reference potential, e.g. a Ag/Ag⁺ reference potential. However, a reference potential will not necessarily be required in all embodiments of the invention.

Suitably, in each electrochemical cycle, the irradiated nuclear graphite is exposed to a potential which gives a current density of from 0.001 to 50 mA/cm², 0.01 to 20 mA/cm², 0.01 to 10 mA/cm², 0.01 to 1 mA/cm², 0.01 to 0.5 mA/cm² or 0.01 to 0.2 mA/cm², alternating between oxidising and reducing potentials. The current density is defined as the amount of current per surface area of irradiated nuclear graphite.

The irradiated nuclear graphite may have a specific surface area of from 0.01 to 10 m²/g, 0.1 to 2 m²/g or from 0.2 to 0.4 m²/g.

The voltage range used will be dictated by the available electrochemical window of the salt being used. For example, in a LiCl—KCl eutectic the voltage range will be between the potentials where Li⁺ reduction and Cl⁻ oxidation occurs. Thus, the voltage range utilised will be between the potentials where the reduction of the cation and oxidation of the anion of the molten salt will occur.

The term “nuclear graphite” in the context of the present invention refers to any grade of graphite specifically manufactured for use within a nuclear facility, e.g. as a moderator, reflector or other structural components.

The term “irradiated nuclear graphite” (or “contaminated nuclear graphite”) in the context of the present invention means nuclear graphite that has been previously used in a nuclear facility. Such uses include but are not limited to use in a material test reactor, in civil and plutonium production reactor and in the generation of medical isotopes.

In the context of the present invention, the nuclear graphite becomes radioactive (i.e. it becomes irradiated nuclear graphite) during use in a nuclear facility. Radioactivity means that the irradiated nuclear graphite may comprise one or more radioactive isotopes, including ¹⁴C, ³H, ³⁶Cl, ⁶⁰Co, ⁹⁰Sr, ¹³⁷Cs, ^{152,154,155}Eu and other fission and/or activation products such as those resulting from isotopes of actinides including U, Np , Pu, Pa, Am and Cm.

Suitably, the irradiated nuclear graphite has a density of at least 0.8 g/cm³, at least 1.5 g/cm³ or at least 1.7 g/cm³.

Suitably, prior to its use in a nuclear facility, the nuclear graphite will have a purity level of less than 5 ppm boron equivalent, as measured according to American Society for Testing and Materials (ASTM) standard C-1233-98.

Suitably, the nuclear graphite has a grain size of 1500 µm or less. More suitably, the nuclear graphite has a grain size of 500 µm or less, most suitably 100 µm or less. Suitably, the nuclear graphite has a minimum grain size of 1 µm.

The irradiated nuclear graphite used in the method of the invention may be in particulate form. Suitably, the irradiated nuclear graphite may have a particle size of from 0.01 mm to 500 mm, 0.01 mm to 200 mm, or from 0.1 mm to 20 mm.

The nuclear graphite, prior to its use in a nuclear facility, may meet one or all of the export control requirements of nuclear graphite. The nuclear graphite may be nuclear grade graphite, i.e. the nuclear graphite may meet one or both of the following definitions:
a. Fine grain graphite with bulk density of 1.72 g/cm³ or greater measured at 288 K (15° C.) having a grain size of 100 microns or less;
b. Virgin graphite having a purity level better than 5 ppm boron equivalent and a density greater than 1.5 g/cm³.

Suitably, the electrochemical treatment comprises a plurality of electrochemical cycles. Thus, the irradiated nuclear graphite may be subjected to a plurality of electrochemical cycles which comprise passing oxidising and reducing potentials through the irradiated nuclear graphite. It has been demonstrated herein that the application of electrochemical cycles (i.e. exposure to both an oxidising and reducing potential) results in the removal of additional contaminants, such as beta contaminants (e.g. tritium and carbon-14), compared to the application of a set current density provided by a single potential. Suitably, the method of the invention will comprise exposing the irradiated nuclear graphite to at least 2, 3, 4, 5, 6, 7, 8, 9 or 10 electrochemical cycles (e.g. from 2 to 20 cycles, 3 to 15 cycles or 5 to 10 cycles) . Suitably, the method of the invention will comprise exposing the irradiated nuclear graphite to at least 5, 6, 7, 8, 9 or 10 electrochemical cycles.

The duration of each electrochemical cycle may be of the order of nanoseconds to several hours. Each electrochemical cycle may comprise a pulse of oxidising potential and a pulse of reducing potential. Thus, a large number of cycles may be applied by in a pulsed manner, where the oxidising and reducing potential switches over a very short period of time.

If the electrochemical cycles are applied in a pulsed manner, the duration of each cycle may be from 0.1 ns to 10 s, 1 µs to 1 s or from 1 ms to 0.1 s.

Alternatively, the electrochemical cycles may be applied over a longer period of time, e.g. the duration of each electrochemical cycle may be from 10 seconds to 10 hours, 10 minutes to 6 hours, or 1 hour to 4 hours.

The electrochemical treatment may be varied throughout the method of the invention. Thus, the electrochemical treatment may comprise a combination of pulsed cycles and longer cycles.

The total duration of the electrochemical treatment will vary depending on the amount of irradiated nuclear graphite to be decontaminated and the types of contaminants present. The electrochemical treatment may be performed until a certain minimum amount of contaminants have been removed. Suitably, the total duration of the electrochemical treatment will be up to 72 hours, for example 1 minute to 72 hours, 30 minutes to 48 hours, 1 hour to 36 hours or from 6 hours to 24 hours.

Suitably, in a particular embodiment, the method of the invention will comprise exposing the irradiated nuclear graphite to at least 2, 3, 4, 5, 6, 7, 8, 9 or 10 electrochemical cycles of from 2 to 6 hours duration each.

The progress of the method of the invention may be monitored by the release of radionuclides from the irradiated nuclear graphite, e.g. into the salt phase and/or off gas phase. Suitably, the progress of the method of the invention may be monitored, e.g. by quantitative gas analysis. Quantitative gas analysis measures the atomic weight of any disposed particle in the gas phase. The progress of the method of the invention may be monitored by the measurement of isotopes released into the salt phase, e.g. by using gamma spectroscopy. Suitably, the progress of the method of the invention may be monitored by gamma spectroscopy.

Suitably, the method may further comprise the removal of contaminants (e.g. radionuclides) that have deposited on electrodes and/or are present in the molten salt.

Suitably, the salt is selected from one or more metal halide salts. Suitably, the molten salt is selected from one or more of alkali metal halide salts and alkaline earth metal halide salts. More suitably, the metal halide salts are selected from one or more alkali metal chlorides, alkali metal fluorides, alkaline earth metal chlorides and alkali earth metal fluorides.

Suitably, the molten salt comprises one or more of LiCl, NaCl, KCl, RbCl, CsCl, BeCl2, MgCl₂, CaCl₂, SrCl2, BaCl₂, LiF, NaF, KF, RbF, CsF, BeF₂, MgF₂, CaF₂, SrF₂ and BaF₂. Suitably, the molten salt comprises one or more of LiCl, NaCl and KCI.

Suitably, the molten salt comprises a mixture of one or more alkali metal halide salts and/or one or more alkaline earth metal halide salts.

The alkali metal halide salt and/or alkaline earth metal halide salts may be present as a eutectic mixture. A eutectic mixture is defined as a mixture of two or more components which usually do not interact to form a new chemical compound but, which at certain ratios, inhibit the crystallisation process of one another resulting in a system having a lower melting point than either of the components. Thus, a eutectic mixture may be utilised to increase the energy efficiency of the method of the invention. However, the use of a eutectic mixture of salts is not essential for the effective decontamination of the irradiated nuclear graphite to be achieved.

Suitably, the molten salt is substantially free from water, i.e. the molten salt comprises less than 0.1 wt.%, less than 0.01 wt.% or less than 0.001 wt.% of water. The presence of water in the molten salt may oxidise the irradiated nuclear graphite, potentially reducing the effectiveness of the method.

The molten salt may further comprise a metal oxide to aid the removal of contaminants from the irradiated nuclear graphite. The metal oxide may be present in an amount of up to 2 wt.% of the molten salt, e.g. 0.01 to 2 wt.%, 0.1 to 0.1 wt.% or 0.2 to 0.5 wt.%. The metal oxide may be selected from alkali metal oxides or alkaline earth metal oxides. The metal oxide may be selected from Li₂O, CaO, MgO.

Suitably, the electrochemical treatment will be performed at a temperature above the melting point of the salt or mixture of salts and below the temperature at which graphite will significantly oxidise and/or notable thermal degradation will occur. Suitably, the molten salt may be heated to a temperature of 350° C. to 700° C., 375° C. to 600° C. or 400° C. to 500° C.

The method of the invention will typically be performed at atmospheric pressure.

The method of the present invention will typically be performed in an atmosphere in which the level of oxygen is controlled. Suitably, there is no more than 2% by volume of oxygen in the atmosphere in which the method of the invention is performed.

Suitably, the method of the present invention is performed in an inert atmosphere. The inert atmosphere may comprise one or more inert gases, e.g. argon or nitrogen.

The irradiated nuclear graphite may be in electrical contact with a first electrode, such that current flows between the first electrode and a second electrode, via the irradiated nuclear graphite. The first electrode will suitably be the working electrode. The second electrode will suitably be a counter electrode. The first and second electrodes may be comprised of any suitable electrode material known those skilled in the art, e.g. tungsten, carbon glass, stainless steel, molybdenum etc.

Suitably, a reference electrode is present within the molten salt. The reference electrode may be a silver/silver chloride (Ag/AgCl) electrode.

The method of the present invention will suitably result in a reduction of at least 70% total gamma activity of the irradiated nuclear graphite, more suitably at least 80% reduction in the total gamma activity of the irradiated nuclear graphite.

Suitably, the activity due to ³H in the irradiated nuclear graphite is reduced by at least 10%, 20%, 30%, 40% or 50%.

Suitably, the activity due to ¹⁴C in the irradiated nuclear graphite is reduced by at least 2.5%, 5%, 10% or 15%.

The method of the present invention will suitably allow the irradiated nuclear graphite to be reclassified. Suitably, the irradiated nuclear graphite may be reclassified from Intermediate Level Waste (ILW) to Low Level Waste (LLW) or suitable equivalent radioactive waste categories used in other countries (in accordance with IAEA Safety Standards, such as No GSG-1) following the application of the method the present invention. Suitably, following the method of the invention, the irradiated nuclear graphite will be decontaminated to have less than 4 GBq/te for alpha activity, 12 GBq/te for combined beta and gamma activity.

Suitably, the irradiated nuclear graphite may be reclassified from Low Level Waste (LLW) to Very Low Level Waste (VLLW) or suitable equivalent radioactive waste categories used in other countries (in accordance with IAEA Safety Standards, such as No GSG-1) following the application of the method from the present invention. VLLW is solid waste containing no single item of more than 40 kBq and concentrations no more than 400 kBq per 0.1 cubic metres for radionuclides other than ³H and ¹⁴C and no single item more than 400 kBq and concentrations no more than 4 MBq per 0.1 cubic metres of H-3 and C-14.

Suitably, the method of the present invention may be performed upstream or downstream of a further method to decontaminate irradiated nuclear graphite.

### BRIEF DESCRIPTION OF THE DRAWINGS

Embodiments of the invention are further described hereinafter with reference to the accompanying drawings, in which:

FIG. 1 shows

A: A photograph of the working electrode with graphite basket;

B: A photograph of an example of the cell used;

C: A schematic design of experimental cell: 1 - Quartz body of the cell, 2 -Borosilicate lid of the cell, 3 - Gas inlet, 4 - Gas outlet, 5 - Alumina crucible, 6 - Mo counter electrode, 7 - W working electrode with graphite basket, 8 -W working electrode for salt check, 9 - Ag/AgCl reference electrode;

FIG. 2 shows

A: Picture of apparatus implemented in the lab;

B: Schematic drawing of the high-temperature molten salt apparatus used for graphite treatment studies : 1 - Vacuum inlet, 2 - Argon inlet, 3 - Oil bubbler to avoid overpressure, 4 - Inlet to the cell, 5 - Cell, 6 - Furnace, 7 - Alumina crucible, 8 - Electrodes, 9 - Digital thermometer, 10 - Potentiostat, 11 -Bubblers for trapping ³H with 20 ml of 1 M HNO₃, 12 - Bubblers for trapping ¹⁴C with 40 ml of Carbon Trap

FIG. 3 shows a comparison of the mean specific activity levels for the range of radioisotopes identified across samples from Oldbury, Sizewell and Wylfa Magnox reactors. The inset graph provides the zoom-in plot for ¹³³Ba, ¹³⁷Cs and ¹⁵⁴Eu showing the distribution of these radioisotopes across the same reactor sites.

FIG. 4 shows the change in total activity of ⁶⁰Co, ¹³³Ba, ¹³⁷Cs and ¹⁵⁴Eu across the samples from Oldbury, Sizewell and Wylfa Magnox reactors. 40 mA absolute magnitude of current. One cycle. Temperature 723 K.

FIG. 5 shows Change in total activity of ⁶⁰Co, ¹³³Ba, ¹³⁷Cs and ¹⁵⁴Eu across the samples from Oldbury, Sizewell and Wylfa Magnox reactors. 1 and 2 after the name of the reactor corresponding to the results of one cycle and two cycles of treatment respectively. 40 mA current. Temperature 723 K.

FIG. 6 shows Change in (A): Total activity of ⁶⁰Co, ¹³³Ba, ¹³⁷Cs and ¹⁵⁴Eu after treatment across a number of samples from different reactors; (B): Total combined value of specific activity of ⁶⁰Co, ¹³³Ba, ¹³⁷Cs and ¹⁵⁴Eu after treatment of samples from Oldbury reactor, - as a function of the absolute magnitude of current passed through the system. The grey region of the graph represents the β/γ specific activity level required for the waste to be categorised as LLW. Two cycles of relevant current applied. Temperature 723 K.

FIG. 7 shows: Change in (A): Total activity of ⁶⁰Co, ¹³³Ba, ¹³⁷Cs and ¹⁵⁴Eu after treatment of a number of samples from different reactors; (B): Total combined value of specific activity of ⁶⁰Co, ¹³³Ba, ¹³⁷Cs and ¹⁵⁴Eu after treatment of samples from Wylfa reactor, - as a function of a number of cycles investigated. The grey region of the graph represents the β/γ specific activity level required for the waste to be categorised as LLW. Two cycles of relevant current applied. Temperature 723 K.

FIG. 8 shows galvanostatic transients recorded under 40 mA negative (black — beginning at the top left of the graph — axis label on left hand side) and 40mA positive (grey - line beginning at the bottom left of the graph - axes label on right hand side) currents applied to irradiated graphite sample from Oldbury reactor placed in LiCl—KCl eutectic at 723 K.

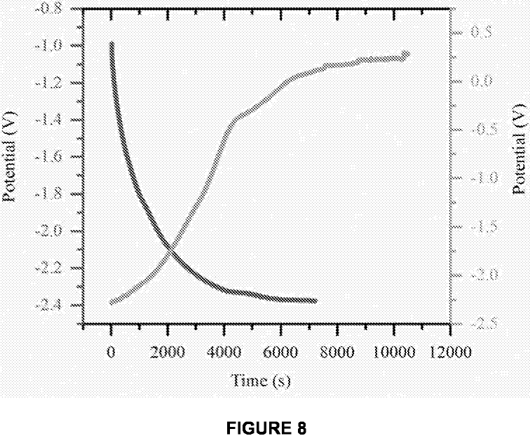

FIG. 9 shows krypton adsorption/desorption isotherms at 77 K for untreated irradiated PGA graphite. Inset SEM micrograph shows surface morphology of untreated graphite. The coloured regions of the micrographs show evidence of slit-shaped pores.

FIG. 10 shows the change of specific surface area (SSA) and mass (m) during electrochemical decontamination in molten salt as a function of (A): Current (mA) for 10 cycles of treated samples; (B): electrochemical treatment cycle number applied for samples treated at 60 mA current.

FIG. 11 shows Scanning electron micrographs of irradiated PGA graphite treated with different currents (mA) during electrochemical decontamination in molten salt. 10 cycle treated samples.

FIG. 12 shows high-resolution C 1 s XPS spectrum with deconvoluted peaks of irradiated PGA graphite treated with a set of currents. In the top left corner, the representative atomic concentrations of the identified bonds are shown. 10 cycle treated samples.

FIG. 13 shows XRD patterns of irradiated PGA graphite treated with a set of currents. Miller indices (hkl) for the corresponding reflections are identified above the peaks. In the top right corner, the representative zoom in plots for (110) reflection are shown. 10 cycle treated samples.

FIG. 14 shows the change in stacking height (Lc) and lateral size (La) as a function of cycle number applied during electrochemical decontamination. 10 cycle treated samples.

FIG. 15 shows the mean specific activity for ³H and ¹⁴C analysed across the various Magnox reactor sites.

FIG. 16 shows the release in off-gas phase for ³H (top) and ¹⁴C (bottom) as a function of current applied during electrochemical treatment. One cycle of relevant current applied. Temperature 723 K. Two samples were analysed for each treatment condition.

FIG. 17 shows the release in off-gas phase for ³H as a function of cycle number applied during electrochemical treatment at 723 K, tested at various currents.

FIG. 18 shows the release in off-gas phase for ¹⁴C as a function of cycle number applied during electrochemical treatment at 723 K, tested at various currents.

### DETAILED DESCRIPTION

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader’s attention is directed to all papers and documents which are filed concurrently with or previous to this specification in connection with this application and which are open to public inspection with this specification, and the contents of all such papers and documents are incorporated herein by reference.

### EXAMPLES

The present invention provides a single approach for the removal of multiple contaminants from irradiated nuclear graphite at a lower temperature compared to “standard” pyrolytic treatment methods.

A novel electrochemical decontamination approach in a high-temperature molten salt medium was applied to irradiated Pile Grade A graphite fixed on the working electrode immersed in LiCl—KCl at 723 K. By optimising the absolute magnitude of current and the number of transitions between positive and negative current, substantial removal of radionuclide contamination (⁶⁰Co, ¹³³Ba, ¹³⁷Cs, ¹⁵⁴Eu) from the irradiated graphite was achieved. Up to 80% reduction of total initial activity for ⁶⁰Co was achieved without significant degradation of the graphite material (<7% mass loss). The magnitude of gamma activity removed from the irradiated graphite was sufficient to reclassify the remaining graphite material from Intermediate Level Waste to Low Level Waste.

### Part 1. Electrochemical Decontamination of PGA Graphite From Corrosion and Fission Products in LiCl—KCl

### Experimental

### Materials

Nuclear graphite grade used for these studies was Pile Grade A (PGA). As an artificially manufactured polycrystalline material, nuclear graphite may contain up to 10 % of closed porosity and up to 20% total porosity [2,32]. Due to the significant radiolytic oxidation in CO₂ gas-cooled reactors, the significant weight loss, and, therefore, the increase in the percentage of porosity, can be expected [33,34]. Irradiated nuclear graphite samples were retrieved from Oldbury, Wylfa and Sizewell Magnox reactor sites in the UK. The graphite was irradiated to ~6 dpa and ~543 K, and an average weight loss of 16% due to radiolytic oxidation was recorded. The solid graphite samples were produced by trepanning a cylinder of 12 mm in diameter from the bulk moderator material, followed by cutting to achieve 6 mm length of the samples. Once received, samples were sliced in half and washed in an ultrasonic bath with acetone to remove any loose surface contamination.

The activity level of each graphite sample was recorded by a High-Purity Germanium (HPGe) Detector gamma spectrometer (Canberra). Data were correlated to sample mass and geometry with the assumption that the graphite geometry remained constant during treatment, and any reduction in mass was due to increased porosity. That assumption was confirmed by the experimental observations.

LiCl and KCl salts (Sigma Aldrich 99%) were separately placed under a vacuum of 1 Pa at 170° C. for 12 hours and mixed in the required proportion (LiCl/(KCl+LiCl) (mol/mol) = 0.6). The mixed salts were fused under vacuum, then the cell was filled with argon and heated up to 450° C. with a temperature ramp rate of 10° C./min and dwelled at that temperature for one hour. Cyclic voltammetry (CV) of the mixed salt was performed to record any impurities (e.g. water, oxygen), and if required, the system was additionally purified by the production of chlorine gas via electrochemical cleaning [35]. The cleaned molten salt was then syringed under an Ar atmosphere, quenched and kept in a dry box before use.

### Apparatus

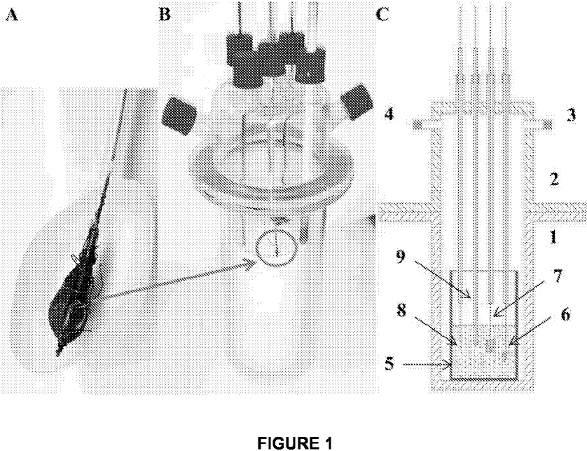

Solid graphite samples were placed in a tungsten mesh basket (50 × 50 mm with 0.05 mm wire diameter), fixed to a tungsten wire (0.01 mm diameter) at the end of a tungsten rod (1 mm diameter) and used as a working electrode (see FIG. 1A). The working electrode was inserted approximately 10 mm into the salt bath during the treatment. The reference electrode was prepared by the addition of 1 % wt AgCl in LiCl—KCl eutectic to a dimulit ceramic tube, to which a silver rod (1 mm diameter) was inserted. Molybdenum wire (0.5 mm diameter) bent in a spiral form was used as a counter electrode.

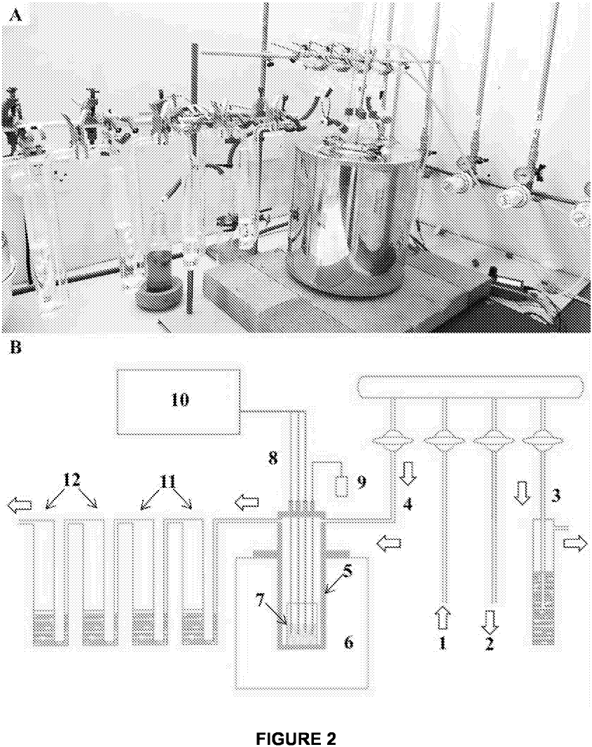

The experimental cell, as shown in FIG. 1B and FIG. 1C, includes such parts as a quartz body with an alumina crucible, a borosilicate lid of the cell with gas inlet and gas outlet fittings to maintain inert argon atmosphere (99.998% BOC Pureshield Argon) during the experiments. The cell was also connected to a chain of bubblers for volatile radioisotopes capture as illustrated on an example of the setup implemented in the lab (FIG. 2A) and schematic drawing (FIG. 2B).

The release of radioisotopes in off-gas during the process was assessed using Liquid Scintillation Counting (LSC) on the liquids from the bubblers containing 20 ml of 1 M HNO₃ and 40 ml Carbon Trap solutions to capture ³H and ¹⁴C, respectively. For further detail on the off-gas analysis see part 3.

The system was heated by a vertical tube furnace (model 75/3 Severn Thermal Solutions) connected to an in-house made temperature controller with nickel-chromium K-type thermocouple. Autolab PGSTAT101 potentiostat controlled via Nova 2.0 software was used to perform all electrochemical measurements (such as cyclic voltammetry and chronopotentiometry).

### Treatment Procedure

For each experiment, 176 g of prepared LiCl—KCl eutectic salt was placed in an alumina crucible, and electrodes were fixed above the salt. The cell was evacuated and filled with argon, then placed under a vacuum of 1 Pa at 473 K for 12 hours to remove any moisture. Next, the system was heated up in the vertical tube furnace up to 723 K with a temperature ramp rate of 10°/min and dwelled at the final temperature for three hours. After the purity of the salt was checked by cyclic voltammetry (CV) by inserting the relevant electrodes into the melt, the working electrode with the graphite sample was then inserted into the melt for treatment studies.

Chronopotentiometry was used as the primary technique for the electrochemical treatment of the graphite sample. The assumption of complete radioisotope transfer was introduced, where the transfer was considered to be completed based on reaching a stable potential on the galvanostatic transients (no further significant increase or decrease was recorded on the galvanostatic transition over several minutes). According to these transitions (for details see Appendix A. FIG. A1), the duration of treatment was sufficient at two and three hours for negative and positive currents, respectively. Therefore, the decontamination procedure started with the application of a negative current to the system for two hours, followed by applying a positive current of the same absolute magnitude applied for three hours. The electrochemical treatment with the application of combined negative and positive currents for a total duration of five hours is herein referred to as one cycle. After the treatment was concluded, the working electrode with graphite was removed from the melt. CV of the remaining salt was performed to detect any impurities following contamination transfer. The system was left to cool down to room temperature over 12 hours. Next, to remove the mesh basket and clean the graphite of salt, the sample was repeatedly washed with hot water. Once extracted, the sample was placed in a sonicating bath of acetone for 15 minutes to remove any residual presence of salt. The change in graphite sample mass due to the washing procedure was within the error of measurement and, therefore, neglected. Activity levels of the graphite and salt were acquired and compared to the values before treatment.

This investigation explored the influence of absolute current and the number of cycles deployed on the levels of graphite decontamination achieved. The currents used were 20, 40, 60 and 80 mA, where no evidence of any significant activity change was detected below 20 mA, which was set as a minimum, and 80 mA was used as a maximum current based on the safety guidelines provided by the equipment supplier. Moreover, each analysed value of current was repeated up to ten cycles. After every four cycles the current was stopped, the graphite extracted, cleaned and then placed in a new basket to ensure graphite was correctly fixed to the working electrode. The electrolysis was continued until the required number of cycles was reached. The current densities used ranged from approximately 0.01 to 0.15 mA/cm² (for details see Appendix D).

To verify the validity of the decontamination data obtained, at least two experiments were carried out for each analysed set of conditions. The standard error associated with each property was estimated by the standard deviation and error propagation methods.

### Results

### Proof of Concept

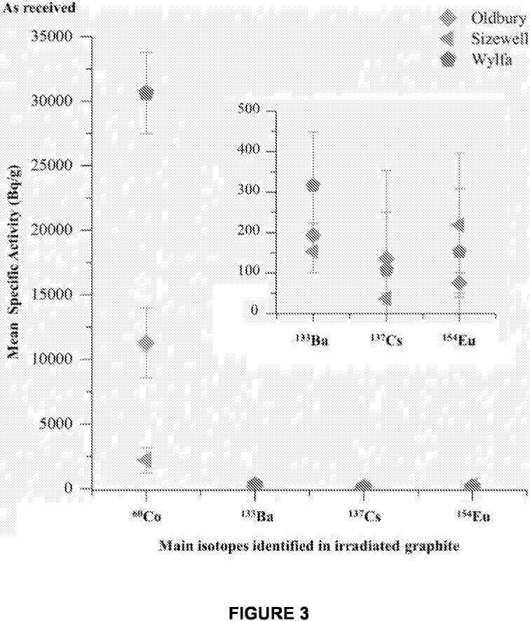

The proof of concept study was carried out using graphite samples from different reactor sites, consisting of variable levels of contamination. That allowed demonstrating the robustness of the proposed electrochemical decontamination method. The comparison of mean specific activity across multiple samples from different sites is presented in FIG. 3.

A significantly high initial activity of ⁶⁰Co, which is the main contributor to the total activity in all samples, was observed especially in the samples extracted from the Wylfa site. The activity release into salt phase without applying of current to the system has revealed no significant change in both activity level and mass of the sample (for details see Appendix A. Table A1). These results were used as a ‘zero’ reference in these studies. After applying 40 mA of positive current, a similar observation with no activity transfer from graphite to the salt was found (for details see Appendix A. Table A2). The positive current was selected based on the required electrochemical reaction to provoke separation of the graphite contamination, most likely present in oxide or carbide, from the bulk of the material. Further attempts were based on the concept of the reverse pulse techniques [36]. To promote the removal of contaminants present in graphite the step of negative current of the same magnitude was introduced as recommended by Gileadi et al. [37]. Significant uncertainty in the determination of transition time during chronopotentiometry was observed most likely due to the variable nature of the irradiated graphite samples. Therefore, the assumption of complete radioisotope transfer was introduced. The transfer was considered to be completed based on reaching a stable potential on the galvanostatic transients. According to these transitions (for details see Appendix A. Table A1), the duration of treatment was sufficient at two and three hours for negative and positive currents, respectively.

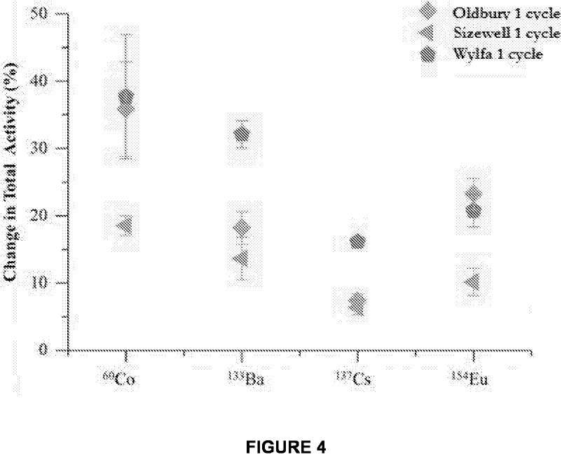

The influence of current with an absolute magnitude of 40 mA on graphite samples from the different reactor sites was tested (for details see Appendix A. Table A3). The change in total activity of ⁶⁰Co, ¹³³Ba, ¹³⁷Cs and ¹⁵⁴Eu was used to compare the release across these samples, and the results are presented in FIG. 4.

The analysis of activity released from graphite samples demonstrated substantial improvements compared to previously used settings (0 mA and positive 40 mA). These results proved the need to use the combination of negative and positive currents of the same magnitude. It is noted that the Wylfa samples exhibit higher percentage activity release then the majority of samples from other sites. These Wylfa samples had the highest values of initial specific activity for almost all radioisotopes relative to these from other reactors. Therefore, the indication that the initial activity of the sample could impact on the level of expected contaminant removal was observed.

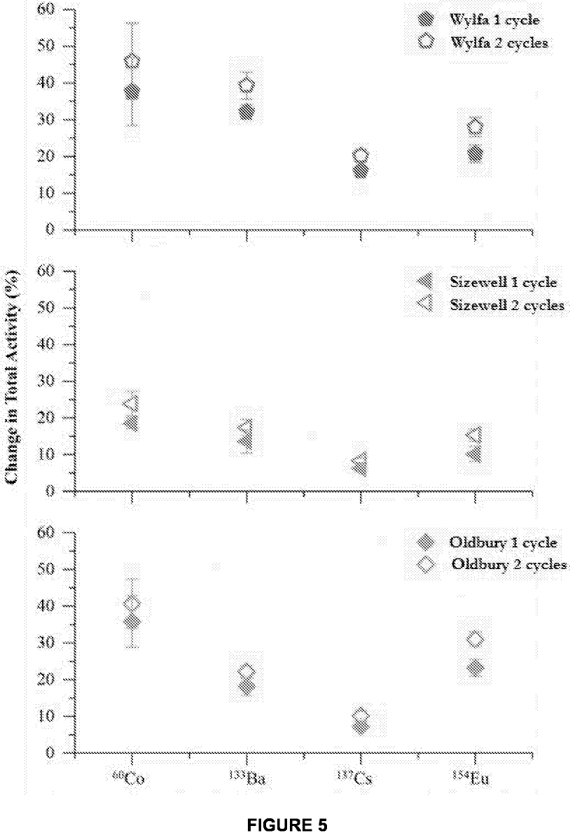

Previous samples after analysis were returned to the salt, and the second cycle of 40 mA current was applied to investigate whether there were any further improvements in radioisotope removal could be made. The results comparing the change in total activity in contrast to the initial value after the additional cycle of treatment (two cycles) and previously achieved change (one cycle) are presented in FIG. 5. For two cycles of treatment, an improvement in the total activity change was found; therefore, the number of cycles became the subject of further investigation in these studies. The influence of current was also required further analysis to be considered as one of the main force to provoke electrochemical treatment.

Altogether, the proof of concept studies showed that significant decontamination of graphite material across different reactor sites was achieved, providing at the same time a negligible change in mass of graphite material, the specific parameters are listed in Appendix A. Table A3.

### The Influence of Current

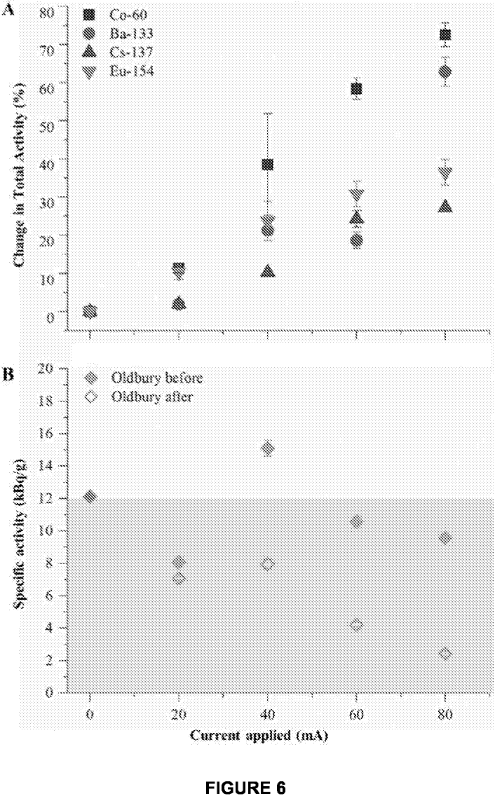

For studies exploring the influence of the absolute magnitude of current passed through the system, the samples across different sites were analysed (see Appendix B). The average reduction in the total activity was estimated after two cycles for the radioisotope set: ⁶⁰Co, ¹³⁷Cs, ¹³³Ba and ¹⁵⁴Eu. The change of total activity for these radioisotopes as a function of current applied to the system is shown in FIG. 6.A.

Analysing for ⁶⁰Co decontamination, a substantial increase in the relative amount of ⁶⁰Co removed from graphite material after increasing the current was observed reaching around 75% of ⁶⁰Co decontamination at 80 mA. For ¹³³Ba decontamination it was found that currents less than 60 mA only gave activity transfer of 25% whereas a decontamination level of 65% for ¹³³Ba was achieved when using 80 mA. For ¹³⁷Cs decontamination a steady increase in removal was observed in respect to the absolute magnitude of current. However, the higher current did not contribute significantly to radioisotope removal, reaching a maximum of 30%. A similar trend was observed with ¹⁵⁴Eu providing 20% removal at 80 mA current.

The total combined value of specific activity of ⁶⁰Co, ¹³³Ba, ¹³⁷Cs and ¹⁵⁴Eu for samples from Oldbury reactor were analysed before and after the treatment. These results were compared to the limit levels for Low Level Waste (LLW), which is 12 kBq/g of β/γ activity [38]. The limits for α activity were not considered due to the lack of such contamination present in analysed samples. The initial activity present in the Oldbury samples was already close to or below the limits for LLW. However, the significant decrease in activity levels obtained by the molten salt treatment using 40 mA current leaves the remaining graphite well below the LLW activity threshold. Moreover, by elevating the absolute magnitude of the current, the removal of the contamination from the graphite in this proposed method can be enhanced (see Appendix B. Table B1).

### The Influence of the Cycle Number

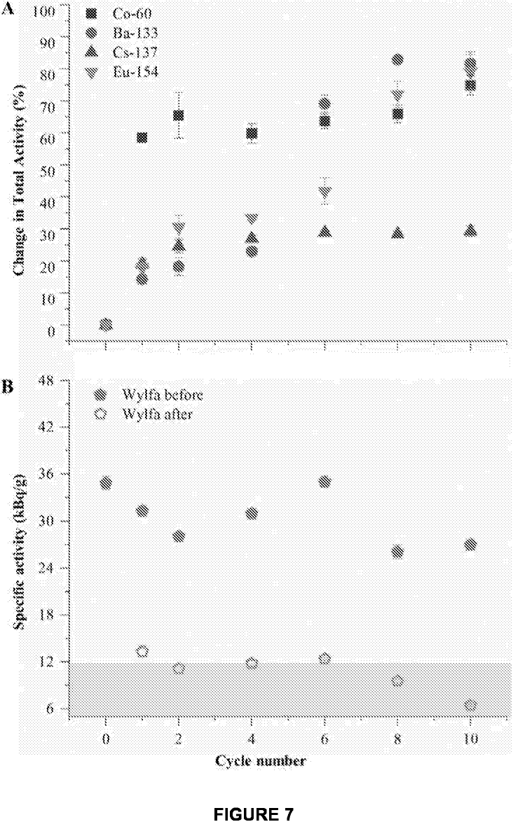

To investigate whether the number of cycles applied to the system could improve the removal of contamination from graphite at a relatively low current, the electrochemical treatment was studied using 60 mA current for a range of cycle numbers (1-10). FIG. 7A shows the change of total activity for ⁶⁰Co, ¹³³Ba, ¹³⁷Cs and ¹⁵⁴Eu as a function of the number of cycles investigated

The results for ⁶⁰Co decontamination showed a decrease in activity the graphite with an increase in cycle number at the set current of 60 mA, showing decontamination of more than 60% of ⁶⁰Co when executed for two cycles. Further cycles gave a gradual increase in ⁶⁰Co removal, achieving greater ⁶⁰Co removal than from 80 mA at two cycles. For ¹³³Ba decontamination, there is a step increase in the amount of radioisotope detected in the salt phase from four to six cycles of treatment with 80% removal achieved for more than eight cycles. ¹³⁷Cs removal showed an increase in transfer to salt phase with the increasing cycle number; however, the radioisotope continued to show the resistance in transfer to the salt phase resulting in less than 40% removal of activity under all conditions tested in this research. In contrast, the decontamination from ¹⁵⁴Eu substantially increased from six to eight cycles, achieving almost 80% transfer to the salt.

The total combined value of specific activity for ⁶⁰Co, ¹³³Ba, ¹³⁷Cs and ¹⁵⁴Eu was analysed using the method described above. The change in total specific activity of these radioisotopes as a function of number of cycles investigated is presented in FIG. 7B. The analysis showed a substantial reduction in activity level (from ~ 30 kBq/g to ~ 12 kBq/g) for samples with high initial activity (for details see Appendix C. Table C1). According to the observed trend, the downgrading of the graphite waste category can be expected after four cycles of electrochemical treatment using 60 mA from samples with a similar level of activity as in the samples used in the current study. Relying on these data, an increase in cycle number can be beneficial when the higher current is not available and can guarantee more effective decontamination comparing to the single treatment.

### Discussion

The release of corrosion and fission products in molten salt media from the irradiated graphite due to electrolysis in a molten salt system was investigated to explore whether this process could be applied to the decontamination of irradiated graphite and to understand the influence of various process parameters on radioisotope transfer into the salt phase. Results show that the molten salt treatment can successfully remove ⁶⁰Co, ¹³³Ba, ¹³⁷Cs and ¹⁵⁴Eu from irradiated PGA graphite and that both the current and number of cycles of applied treatment play a crucial role in achieving a downgrading of the graphite waste level. The influence of three main factors (electrolysis, oxygen, contaminations) on the achieved reduction in activity will be discussed in detail below.

### Influence of Electrolysis

The nature of the graphite cathode behaviour during electrolysis has been studied by Simonet et al. [39]. The graphite layers were reported to perform in a similar manner to polycondensed aromatic hydrocarbon, whereby it can accept electrons on its surface and accommodate a particular level of charge. When such a charge forms near the surface, it will attract cations from the salt to neutralise it, therefore acting as a chemical reducing agent. That can result in weaker bonding between the graphite layers. However, the breakage or complete destruction of bonds can only be the result of significantly larger cations [39]. When acting as an anode in chloride media, graphite was reported to behave similarly to the metal corrosion model [40]. Chloride ions can react with a graphite surface forming a compound that would act as a barrier protecting the surface from further interference. The layer will develop slowly in time, and overextended contact with salt can lead to the destruction of graphite outer layers [41]. The significant release of radioisotopes during the proof of concept studies with negligible reduction in graphite mass suggests that irradiated nuclear graphite shows the same response to the electrochemical procedure as general graphite grades.

### Influence of Oxygen

From the previous studies by Janssen [42] it is known that the mechanism of chloride evolution on the graphite surface highly depends on the content of oxygen present in the system. The experiments were conducted under a controlled oxygen-free atmosphere. However, the possible presence of the oxygen species on the surface of as received graphite due to the radiolytic oxidation could not be avoided. Other researchers have successfully identified the oxidic groups present on the irradiated graphite surface as —C═O, —COOH, —C—OH [43-45]. Therefore the following reactions (see Equations 1-4) can be considered for the present system, where the presence of O²⁻ ion is due to the degradation of oxygen-containing groups present on the graphite surface [42,46]:

$$2 {\text{Cl}}^{\text{-}} \to {\text{Cl}}_{2} + 2 {\text{e}}^{\text{-}}$$

$${\text{O}}^{2 \text{-}} \to \frac{1}{2} {\text{O}}_{2} + 2 {\text{e}}^{\text{-}}$$

$${\text{O}}^{2 \text{-}} + \text{C} \to \text{CO} + 2 {\text{e}}^{\text{-}}$$

$${\text{2O}}^{2 \text{-}} + \text{C} \to {\text{CO}}_{2} + 4 {\text{e}}^{\text{-}}$$

Evidence of a definite link between the discharge of CO and CO₂ and mass loss of graphite was reported in previous studies [41,47]. During these studies, the insignificant loss in graphite during electrolysis in molten salts is most likely due to the limited presence of O²⁻ species in the present system. Moreover, the report of the disintegration of nuclear graphite matrix during electrolysis in nitric acid solutions [30], showed the importance of requiring active oxygen to starting that process, and that just the presence of intercalating anions would not contribute to graphite degradation.

### Influence of Contaminations

Vulpius et al. [20] suggested that a possible mechanism of release of metal ions from the graphite matrix during electrolysis could also be associated with the electromigration. These studies reported a high total amount of release for both ⁹⁰Sr and ¹³⁷Cs during the electrolysis in 5% nitric acid from irradiated graphite. In contrast, a relatively low release of ⁶⁰Co was observed under these decontamination conditions. It is possible that a relatively high level of ⁶⁰Co release in the molten salt media during these studies could also be associated with increased temperature, comparing to the previously mentioned studies, which promotes more ionic movement in the system [48]. Moreover, it has been observed, that the increase of current provokes an increased speed of reactions at the electrodes [49]; therefore, the increasing production of chlorine gas. The formation of chlorine gas, as well as an overall rise in the system dynamic, leads to sufficient mass transfer. A similar effect has also been observed before by Meirbekova et al. [50] during the studies of current efficiency in aluminium reduction process.

While considering the results of activity release from graphite material, it is essential to consider the nature of boundaries between contaminants and graphite, due to the influence of operating conditions in the reactor on the graphite, the simultaneous presence of ionic, oxide or carbide forms could be found on the graphite surface. Cobalt carbide, which is one of the most stable forms of cobalt, was identified on the surface of irradiated graphite [20]. As it has been stated previously that the weak boundaries in the graphite would be detached from its surface in the first instance, while the significant force may be required to remove the stable form [47]. That could explain the partial removal observe in the current studies. When defining the mechanism of radioisotope release from the bulk of the material, the influence of constant current on the material surface during electrochemical reduction should be taken into consideration, where that process was reported to be focused on grain boundaries [51], which in case of nuclear graphite are present by filler and binder particles. With most of the studies [3,52-54] reported contamination in the irradiated graphite located near or inside the pore systems, the more significant influence of current on contamination removal rather than on degradation of the bulk the material may be explained. However, contamination due to the activation of natural impurities is likely to be in a barely accessible or closed pore system. That will require manipulation of the graphite (e.g. crushing) and/or longer treatment durations to promote salt penetration. This research demonstrates that both the current and cycle number appears to contribute to the final level of radioisotope removal is in good agreement with analogous processes discussed previously. Moreover, the radius of the cation of the dissolving metal, its reduction potential in this system (see Table 1), as well as interfacial tension at the metal-salt interface, and can influence the extent of radioisotopes removal.

TABLE 1

Standard reduction potentials for half-reaction vs Cl₂/Cl⁻ and effective ionic radius

| M^{x}+ /M^{y+} | E° , V vs. Cl₂/Cl⁻ | R [55], Å |
|---|---|---|
| Co ²⁺/ Co⁰ | -1.279 [56] | 0.58 |
| Eu ³⁺/ Eu ²⁺ | -0.860 [57] | 1.17 |
| Ba ²⁺/ Ba⁰ | -3.74 [58] | 1.35 |
| Cs⁺/Cs⁰ | -4.316 [59] | 1.67 |
| Li+ / Li⁰ | -3.626 [60] | 0.59 |

All aspects discussed above contribute to the final amount of contamination transferred into the salt and therefore, can explain partial removal (¹³⁷Cs and ¹⁵⁴Eu) observed during these studies. This research shows that with the appropriate selection of process conditions, the downgrading of the waste category can be achieved.

### Conclusions

The irradiated graphite decontamination from corrosion and fission products via electrochemical treatment in the high-temperature molten salt environment has been studied for the first time. The working electrode contained an irradiated graphite sample and the release of radionuclides from graphite into the salt phase was assessed for different Magnox reactor sites.

These investigations showed that the magnitude of applied current and the number of switches between the reduction and oxidation conditions (cycles) plays a significant role in the overall activity removal of ⁶⁰Co, ¹³³Ba, ¹³⁷Cs and ¹⁵⁴Eu. Moreover, this research has proved that by the lower current with an extended number of cycles, a significant improvement could be achieved in the removal of analysed radioisotopes, resulting in an average of 80% of initial activity transfer into the salt phase.

The main advantage of the proposed method is that the category of graphite waste can be reduced without destruction of the material. The suggested mechanism involves a combination of mass transfer due to electromigration with electrochemical reduction by targeting specific elements without significant oxidation of graphite surface. The corrosion and fission products in the remaining salt phase can be separated by electrorefining [61] or extracted using zeolites [62], reducing the waste volume requiring managed disposal and allowing the salt to be recycled too.

As a proof of concept study, this research has shown promising potential for future development and improvement of the molten salt method. Future work will explore whether this method can achieve decontamination for graphite other than PGA. Future work will also involve the assessment of off-gas release for such radioisotopes, e.g. ³H and ¹⁴C, and whether this process can be scaled up to meet industrial capacity.

### APPENDICES FOR PART 1

### Appendix A

### Supplementary Data for the Proof of Concept

TABLE A.1

Specific Activity change in graphite samples during leaching studies in LiCI-KCI eutectic at 723 K (0 mA current)

| No | Sample ID* | Current, mA | m _{before}, g | m _{after}, g | Isotope | A _{before} Bq/g | A _{after**} Bq/g |
|---|---|---|---|---|---|---|---|
| 1 | O_1 | 0 | 0.2172 | 0.2172 | ⁶⁰Co | 12145.87 | 12139.80 |
| | | | | | ¹³³Ba | 228.80 | 228.50 |
| | | | | | ¹³⁷Cs | 82.70 | 82.30 |
| | | | | | ¹⁵⁴Eu | 73.20 | 72.90 |
| 2 | S_1 | 0 | 0.4574 | 0.4574 | ⁶⁰Co | 1489.66 | 1489.06 |
| | | | | | ¹³³Ba | 204.00 | 203.80 |
| | | | | | ¹³⁷Cs | 38.50 | 38.40 |
| | | | | | ¹⁵⁴Eu | 55.90 | 55.60 |
| 3 | W_1 | 0 | 0.4294 | 0.4294 | ⁶⁰Co | 34870.12 | 34859.66 |
| | | | | | ¹³³Ba | 423.70 | 423.40 |
| | | | | | ¹³⁷Cs | 41.40 | 41.20 |
| | | | | | ¹⁵⁴Eu | 146.30 | 145.60 |

* - O - Oldbury Magnox reactor, S - Sizewell Magnox reactor, W - Wylfa Magnox reactor ** - the 5 hours of leaching was tested.

TABLE A.2

Specific Activity change in graphite samples during the application of positive current in LiCl—KCl eutectic at 723 K (40 mA)

| No | Sample ID* | Current, mA | m _{before}, g | m _{after}, g | Isotope | A _{before} Bq/g | A _{after} Bq/g |
|---|---|---|---|---|---|---|---|
| 1 | O_1 | 0 | 0.2172 | 0.2172 | ⁶⁰Co | 12139.80 | 12136.16 |
| | | | | | ¹³³Ba | 228.50 | 228.40 |
| | | | | | ¹³⁷Cs | 82.30 | 82.20 |
| | | | | | ¹⁵⁴Eu | 72.90 | 72.40 |
| 2 | S_1 | 0 | 0.4574 | 0.4574 | ⁶⁰Co | 1489.06 | 1488.47 |
| | | | | | ¹³³Ba | 203.80 | 203.70 |
| | | | | | ¹³⁷Cs | 38.40 | 38.30 |
| | | | | | ¹⁵⁴Eu | 55.60 | 55.30 |
| 3 | W_1 | 0 | 0.4294 | 0.4294 | ⁶⁰Co | 34859.66 | 34849.20 |
| | | | | | ¹³³Ba | 423.40 | 423.00 |
| | | | | | ¹³⁷Cs | 41.20 | 41.20 |
| | | | | | ¹⁵⁴Eu | 145.60 | 144.70 |

* - O - Oldbury Magnox reactor, S - Sizewell Magnox reactor, W - Wylfa Magnox reactor

TABLE A.3

Activity level in graphite samples after electrochemical treatment (40 mA current, up to 2 cycles) in LiCl—KCl eutectic at 723 K

| N° | Sample ID | Current, mA | m _{before}, g | m ₁ g | m ₂ g | Isotope | A _{before} Bq/g | A₁ Bq/g | A₂ Bq/g |
|---|---|---|---|---|---|---|---|---|---|
| 1 | O_1 | 40 | 0.217 | 0.215 | 0.213 | ⁶⁰Co | 12136.16 | 8669.65 | 8095.44 |
| | | | | | | ¹³³Ba | 228.40 | 187.78 | 179.48 |
| | | | | | | ¹³⁷Cs | 82.20 | 76.45 | 74.65 |
| | | | | | | ¹⁵⁴Eu | 72.40 | 54.94 | 50.12 |
| 2 | O_2 | 40 | 0.387 | 0.387 | 0.386 | ⁶⁰Co | 14014.56 | 9119.00 | 8521.00 |
| | | | | | | ¹³³Ba | 213.69 | 180.66 | 171.41 |
| | | | | | | ¹³⁷Cs | 78.32 | 73.41 | 71.65 |
| | | | | | | ¹⁵⁴Eu | 77.42 | 61.21 | 55.11 |
| 3 | O_3 | 40 | 0.232 | 0.230 | 0.229 | ⁶⁰Co | 15114.12 | 8639.09 | 7955.35 |
| | | | | | | ¹³³Ba | 219.65 | 176.24 | 170.68 |
| | | | | | | ¹³⁷Cs | 80.23 | 74.88 | 73.05 |
| | | | | | | ¹⁵⁴Eu | 80.06 | 62.06 | 55.86 |
| 4 | S_1 | 40 | 0.457 | 0.455 | 0.452 | ⁶⁰Co | 1488.47 | 1224.44 | 1201.78 |
| | | | | | | ¹³³Ba | 203.70 | 170.95 | 166.01 |
| | | | | | | ¹³⁷Cs | 38.30 | 36.22 | 35.63 |
| | | | | | | ¹⁵⁴Eu | 55.30 | 51.60 | 48.82 |
| 5 | S_2 | 40 | 0.459 | 0.458 | 0.448 | ⁶⁰Co | 3639.96 | 2911.55 | 2823.33 |
| | | | | | | ¹³³Ba | 156.43 | 134.60 | 132.75 |
| | | | | | | ¹³⁷Cs | 26.92 | 24.96 | 25.12 |
| | | | | | | ¹⁵⁴Eu | 51.46 | 46.35 | 44.86 |
| 6 | S_3 | 40 | 0.237 | 0.236 | 0.237 | ⁶⁰Co | 1299.39 | 1079.15 | 950.44 |
| | | | | | | ¹³³Ba | 224.63 | 202.41 | 190.73 |
| | | | | | | ¹³⁷Cs | 63.13 | 60.00 | 58.42 |
| | | | | | | ¹⁵⁴Eu | 67.52 | 59.47 | 56.09 |
| 7 | W_1 | 40 | 0.429 | 0.428 | 0.426 | ⁶⁰Co | 34849.20 | 19100.22 | 15769.33 |
| | | | | | | ¹³³Ba | 423.00 | 297.56 | 276.88 |
| | | | | | | ¹³⁷Cs | 41.20 | 34.97 | 33.90 |
| | | | | | | ¹⁵⁴Eu | 144.70 | 120.19 | 107.59 |
| 8 | W_2 | 40 | 0.600 | 0.596 | 0.595 | ⁶⁰Co | 29726.33 | 21719.08 | 19568.23 |
| | | | | | | ¹³³Ba | 373.31 | 254.35 | 217.05 |
| | | | | | | ¹³⁷Cs | 67.69 | 56.83 | 53.28 |
| | | | | | | ¹⁵⁴Eu | 149.05 | 117.78 | 111.12 |
| 9 | W_3 | 40 | 0.458 | 0.457 | 0.454 | ⁶⁰Co | 29726.33 | 17791.39 | 15607.13 |
| | | | | | | ¹³³Ba | 26.94 | 17.82 | 16.21 |
| | | | | | | ¹³⁷Cs | 70.65 | 59.46 | 56.97 |
| | | | | | | ¹⁵⁴Eu | 170.32 | 131.99 | 118.53 |

* - O - Oldbury Magnox reactor, S - Sizewell Magnox reactor, W - Wylfa Magnox reactor

### Appendix B

### Supplementary Data for the Influence of Applied Current

TABLE B.1

Activity level in graphite samples after electrochemical treatment (up to 80 mA current, two cycles) in LiCl—KCl eutectic at 723 K

| N° | Sample ID | Current, mA | Cycle N° | m _{before}, g | m _{after} g | Isotope | A _{before} Bq/g | A _{after} Bq/g |
|---|---|---|---|---|---|---|---|---|
| 1 | O_3 | 40 | 2 | 0.232 | 0.229 | ⁶⁰Co | 15114.12 | 7955.35 |
| | | | | | | ¹³³Ba | 219.65 | 170.68 |
| | | | | | | ¹³⁷Cs | 80.23 | 73.05 |
| | | | | | | ¹⁵⁴Eu | 80.06 | 58.78 |
| 2 | O_4 | 20 | 2 | 0.487 | 0.486 | ⁶⁰Co | 8070.00 | 7083.47 |
| | | | | | | ¹³³Ba | 205.19 | 202.54 |
| | | | | | | ¹³⁷Cs | 79.02 | 77.14 |
| | | | | | | ¹⁵⁴Eu | 69.32 | 61.29 |
| 3 | O_5 | 60 | 2 | 0.380 | 0.377 | ⁶⁰Co | 10575.68 | 4216.78 |
| | | | | | | ¹³³Ba | 207.09 | 166.42 |
| | | | | | | ¹³⁷Cs | 85.26 | 63.65 |
| | | | | | | ¹⁵⁴Eu | 71.36 | 51.39 |
| 4 | O_6 | 80 | 2 | 0.384 | 0.381 | ⁶⁰Co | 9573.28 | 2431.91 |
| | | | | | | ¹³³Ba | 142.58 | 49.52 |
| | | | | | | ¹³⁷Cs | 82.98 | 60.99 |
| | | | | | | ¹⁵⁴Eu | 81.35 | 50.01 |
| 5 | S_4 | 20 | 2 | 0.616 | 0.615 | ⁶⁰Co | 2952.99 | 2652.32 |
| | | | | | | ¹³³Ba | 93.44 | 91.40 |
| | | | | | | ¹³⁷Cs | 27.96 | 27.59 |
| | | | | | | ¹⁵⁴Eu | 79.48 | 72.49 |
| 6 | S_5 | 40 | 2 | 0.600 | 0.599 | ⁶⁰Co | 2839.30 | 2017.70 |
| | | | | | | ¹³³Ba | 146.80 | 118.55 |
| | | | | | | ¹³⁷Cs | 54.69 | 48.98 |
| | | | | | | ¹⁵⁴Eu | 731.56 | 585.70 |
| 7 | S_6 | 80 | 2 | 0.315 | 0.314 | ⁶⁰Co | 2862.45 | 853.05 |
| | | | | | | ¹³³Ba | 193.56 | 77.48 |
| | | | | | | ¹³⁷Cs | 24.68 | 17.93 |
| | | | | | | ¹⁵⁴Eu | 81.43 | 53.83 |
| 8 | W_4 | 60 | 2 | 0.5872 | 0.5855 | ⁶⁰Co | 28049.32 | 12266.30 |
| | | | | | | ¹³³Ba | 217.77 | 180.90 |
| | | | | | | ¹³⁷Cs | 39.13 | 30.34 |
| | | | | | | ¹⁵⁴Eu | 174.60 | 116.95 |

* - O - Oldbury Magnox reactor, S - Sizewell Magnox reactor, W - Wylfa Magnox reactor

### Appendix C

### Supplementary Data for the Influence of the Cycle Number

TABLE C.1

Activity level in graphite samples after electrochemical treatment (60 mA current, up to 10 cycles) in LiCl—KCl eutectic at 723 K

| No | Sample ID | Current, mA | Cycle No | m before, g | m after g | Isotope | A before Bq/g | A after Bq/g |
|---|---|---|---|---|---|---|---|---|
| 1 | W_4 | 60 | 2 | 0.587 | 0.586 | ⁶⁰Co | 28049.32 | 10859.76 |
| | | | | | | ¹³³Ba | 217.77 | 174.30 |
| | | | | | | ¹³⁷Cs | 39.13 | 29.09 |
| | | | | | | ¹⁵⁴Eu | 174.60 | 116.95 |
| 2 | W_5 | 60 | 1 | 0.449 | 0.446 | ⁶⁰Co | 31297.56 | 13317.47 |
| | | | | | | ¹³³Ba | 363.16 | 316.78 |
| | | | | | | ¹³⁷Cs | 566.37 | 455.36 |
| | | | | | | ¹⁵⁴Eu | 136.66 | 109.87 |
| 3 | W_6 | 60 | 4 | 0.498 | 0.497 | ⁶⁰Co | 30954.34 | 11810.84 |
| | | | | | | ¹³³Ba | 228.76 | 177.74 |
| | | | | | | ¹³⁷Cs | 64.92 | 48.09 |
| | | | | | | ¹⁵⁴Eu | 123.55 | 83.12 |
| 4 | W_7 | 60 | 6 | 0.265 | 0.260 | ⁶⁰Co | 35014.78 | 12396.33 |
| | | | | | | ¹³³Ba | 263.51 | 77.67 |
| | | | | | | ¹³⁷Cs | 39.04 | 28.34 |
| | | | | | | ¹⁵⁴Eu | 156.32 | 87.86 |
| 5 | W_8 | 60 | 8 | 0.217 | 0.213 | ⁶⁰Co | 26072.99 | 9581.60 |
| | | | | | | ¹³³Ba | 453.22 | 83.20 |
| | | | | | | ¹³⁷Cs | 379.62 | 275.04 |
| | | | | | | ¹⁵⁴Eu | 161.03 | 50.73 |
| 6 | W_9 | 60 | 10 | 0.491 | 0.472 | ⁶⁰Co | 26978.51 | 6466.24 |
| | | | | | | ¹³³Ba | 440.95 | 72.42 |
| | | | | | | ¹³⁷Cs | 71.97 | 52.08 |
| | | | | | | ¹⁵⁴Eu | 163.58 | 29.01 |
| 7 | W_10 | 60 | 8 | 0.459 | 0.448 | ⁶⁰Co | 33648.72 | 11069.53 |
| | | | | | | ¹³³Ba | 369.85 | 62.01 |
| | | | | | | ¹³⁷Cs | 51.33 | 38.04 |
| | | | | | | ¹⁵⁴Eu | 144.24 | 37.10 |
| 8 | S_7 | 60 | 1 | 0.235 | 0.235 | ⁶⁰Co | 957.43 | 389.57 |
| | | | | | | ¹³³Ba | 86.31 | 73.18 |
| | | | | | | ¹³⁷Cs | 39.47 | 32.40 |
| | | | | | | ¹⁵⁴Eu | 82.64 | 69.49 |
| 9 | S_8 | 60 | 2 | 0.488 | 0.486 | ⁶⁰Co | 1684.59 | 499.90 |
| | | | | | | ¹³³Ba | 113.89 | 95.73 |
| | | | | | | ¹³⁷Cs | 59.64 | 46.03 |
| | | | | | | ¹⁵⁴Eu | 597.32 | 431.92 |
| 10 | O_7 | 60 | 4 | 0.469 | 0.464 | ⁶⁰Co | 10845.90 | 4634.50 |
| | | | | | | ¹³³Ba | 147.63 | 114.20 |
| | | | | | | ¹³⁷Cs | 76.95 | 56.21 |
| | | | | | | ¹⁵⁴Eu | 81.35 | 54.19 |
| 11 | O_8 | 60 | 6 | 0.457 | 0.452 | ⁶⁰Co | 8784.59 | 3378.87 |
| | | | | | | ¹³³Ba | 213.53 | 71.03 |
| | | | | | | ¹³⁷Cs | 86.54 | 62.20 |
| | | | | | | ¹⁵⁴Eu | 67.23 | 41.59 |
| 14 | O_9 | 60 | 10 | 0.4908 | 0.4716 | ⁶⁰Co | 8573.28 | 2433.44 |
| | | | | | | ¹³³Ba | 163.54 | 35.63 |
| | | | | | | ¹³⁷Cs | 75.69 | 56.52 |
| | | | | | | ¹⁵⁴Eu | 75.63 | 19.40 |

* - O - Oldbury Magnox reactor, S - Sizewell Magnox reactor, W - Wylfa Magnox reactor

### Appendix D

### Supplementary Data for the Influence of the Cycle Number

The current density was calculated using the D.1 equation:

$$j = \frac{I}{A \times {10}^{4}}$$

Where j is the current density (mA/cm²), / is the total current passed through the system in (mA), A is the total surface area of the analysed sample (m²).

The total surface area was calculated using equation D.2:

$$\text{A} \text{=} \text{SSA} \times \text{m}$$

Where SSA is the specific surface area of the analysed sample (m²/g), m is the mass of the analysed sample (g).

The example of current density values used during the graphite treatment studies in the molten salts is presented in Table D.1.

TABLE D.1

Current density values used during graphite treatment studies in LiCl—KCl eutectic at 723 K

| N◦ | Sample ID* | Current, mA | Cycle No | m before, g | SSA before m²/g | A m² | J mA/cm² |
|---|---|---|---|---|---|---|---|
| 1 | S_7 | 60 | 1 | 0.235 | 0.195 | 0.05 | 0.13 |
| 2 | W_5 | 60 | 1 | 0.449 | 0.351 | 0.16 | 0.04 |
| 3 | S_8 | 60 | 2 | 0.488 | 0.158 | 0.08 | 0.08 |
| 4 | W_4 | 60 | 2 | 0.587 | 0.209 | 0.12 | 0.05 |
| 5 | O_7 | 60 | 4 | 0.469 | 0.241 | 0.11 | 0.05 |
| 6 | W_6 | 60 | 4 | 0.498 | 0.161 | 0.08 | 0.07 |
| 7 | O_8 | 60 | 6 | 0.457 | 0.271 | 0.12 | 0.05 |
| 8 | W_7 | 60 | 6 | 0.265 | 0.235 | 0.06 | 0.10 |
| 9 | W_10 | 60 | 8 | 0.459 | 0.185 | 0.08 | 0.07 |
| 10 | W_8 | 60 | 8 | 0.217 | 0.241 | 0.05 | 0.11 |
| 11 | S_10 | 0 | 10 | 0.458 | 0.185 | 0.08 | 0.00 |
| 12 | S_9 | 0 | 10 | 0.238 | 0.124 | 0.03 | 0.00 |
| 13 | O_4 | 20 | 10 | 0.487 | 0.134 | 0.07 | 0.03 |
| 14 | S_4 | 20 | 10 | 0.616 | 0.232 | 0.14 | 0.01 |
| 15 | O_3 | 40 | 10 | 0.232 | 0.152 | 0.04 | 0.11 |
| 16 | S_5 | 40 | 10 | 0.6 | 0.23 | 0.14 | 0.03 |
| 17 | O_9 | 60 | 10 | 0.401 | 0.241 | 0.10 | 0.06 |
| 18 | W_9 | 60 | 10 | 0.491 | 0.158 | 0.08 | 0.08 |
| 19 | O_6 | 80 | 10 | 0.384 | 0.138 | 0.05 | 0.15 |
| 20 | S_6 | 80 | 10 | 0.315 | 0.291 | 0.09 | 0.09 |

### Part 2 - Evolution of Irradiated PGA Graphite Microstructure Under Molten Salt Decontamination Conditions

This research has explored the evolution of the irradiated graphite microstructure under proposed molten salt decontamination conditions for the removal of corrosion and fission products. The material behaviour and structural changes under molten salt conditions have been assessed using multiple characterisation techniques, and optimised process parameters have been analysed to ascertain the extent of material degradation.

### Experimental

### Sample Preparation

Nuclear graphite grade used for these studies was Pile Grade A (PGA). As an artificially manufactured polycrystalline material, nuclear graphite may contain up to 10 % of closed porosity and up to 20% total porosity [2,32]. Due to the significant radiolytic oxidation in CO₂ gas-cooled reactors, the significant weight loss, and, therefore, the increase in the percentage of porosity, can be expected [33,34]. Irradiated nuclear graphite samples were retrieved from Oldbury, Wylfa and Sizewell Magnox reactor sites in the UK. The graphite was irradiated to ~6 dpa and ~543 K, and an average weight loss of 16% due to radiolytic oxidation was recorded. The solid graphite samples were produced by trepanning a cylinder of 12 mm in diameter from the bulk moderator material, followed by cutting to achieve 6 mm length of the samples. Once received, samples were sliced in half and washed in an ultrasonic bath with acetone to remove any loose surface contamination.

To achieve a scratch-free surface, the specimens were mounted in a custom-made polishing jig and manually ground using silicon carbide abrasive papers with a range of grits (800 - 4000), finishing with a final polish on woven wool cloth using a set of 5 µm, 1 µm and 0.25 µm diamond suspensions. Then cleaned samples were treated in a molten salt environment using various process parameters to optimise radioisotope transfer into the salt phase. The treatment studies were conducted under an Ar atmosphere in LiCl—KCl eutectic at 723 K with a range of electrical currents (up to 80 mA) and a number of electrochemical cycles (up to 10). For the purpose of this study, the electrochemical treatment with the application of combined negative and positive currents for a total duration of five hours is referred to as one electrochemical cycle. The full procedure of the treatment has been described in detail previously (see part 1) [63]. Once retrieved, the samples were cleaned multiple times from salt and any loose contamination in an ultrasonic system with acetone. Graphite samples exposed to molten salt without application of current are referred to as untreated graphite and marked as 0 mA.

### Characterisation Methods

Krypton adsorption isotherms were used to establish the evolution of the specific surface area of irradiated graphite specimens. The isotherms were recorded at 77 K with a Micromeritics Tristar II surface area and porosity analyser. Prior to adsorption measurements, all specimens were placed in the VacPrep 061 degassing unit for 12 hours under vacuum (<0.2 Pa) at 473 K. The adsorption isotherms were recorded at least three times for each specimen to ensure replicability of the method. The collected data was manipulated using the MicroActive and OriginPro software. The Brunauer-Emmett-Teller (BET) method [64] seen in Equation (5) was used to obtain the monolayer adsorbed gas quantity:

$$\frac{1}{V \left[\left({P}^{0} / P\right) - 1\right]} = \frac{1}{{V}_{m} \times C} + \frac{C - 1}{{V}_{m} \times C} \left(P / {P}^{0}\right)$$

where P is the partial vapour pressure of Kr recorded while in equilibrium with the sample surface, P⁰ is the saturated pressure of Kr, V is the quantity of adsorbed gas, Vₘ is the volume of the monolayer cm³/g and C represents the BET constant. The linear range of the BET plot was determined by the increasing range of V[1 - P/P⁰] as a function of P/P⁰, as proposed by Rouquerol et al. [65]. In the linear relative pressure range (P/P⁰), the volume of monolayer (Vₘ) was determined by the slope (s) and intercept (i) of the plot of 1/V[(P/P⁰) - 1] against P/P⁰, and used for the Specific Surface Area (SSA) calculation as seen in Equation (6 - 7) :

$${V}_{m} = 1 / \left(s + i\right)$$

$$S S A = {V}_{m} \times {N}_{a} \times {a}_{m} \text{/} m$$

where Nₐ is Avogadro’s number, m is the mass of graphite specimen in g and aₘ is a molecular projected area, where 0.21 ×10⁻⁹ m²/atom is used for krypton.

FEI Nova NanoSEM 450 scanning electron microscope (SEM) was used to observe the change in the microstructure subject to molten salt treatment at an acceleration voltage of 5 kV. The low voltage was used to prevent damage to the surface of the specimen.

X-ray photoelectron spectroscopy (XPS) was carried out with a Kratos Axis Ultra DLD using the monochromatic Al-Kα source (15 kV, 50 W) and photon energy of 1486.7 eV. Measurements were conducted in a vacuum of 4.6×10⁻⁷ Pa with a charge neutraliser compensation at the emission angles of 0°, 30°, 45° and 60°. Four spots of 300×700 µm were measured on each sample. The survey scan was obtained at 40 eV pass energy with a step size of 0.5 eV for the 0-1300 eV range. The high-resolution scans were obtained at 20 eV pass energy with a step size of 0.1 eV.

X-ray diffraction (XRD) was used to establish the crystallinity and structural parameters of graphite samples after the treatment. The measurements were undertaken using a Philips X′Pert-PRO theta-theta PW3050/60 diffractometer (480 mm in diameter). A 1D-detector in Bragg-Brentano geometry was employed using a Copper Line Focus X-ray tube with Kα ratio 0.5, Kα_{average}=1.542 Å. The incident beam mask of 5 mm and programmable automated divergence slit were used. Data were collected from 20 to 120° coupled 2θ/θ at 0.05° step with 2.5 s/step. Data were manipulated using OriginPro software. After the background subtraction, the XRD patterns were analysed for the recorded peaks. The peaks observed at 2θ around 26° and 77° were assigned to the (002) and (110) diffraction peaks of carbon respectively. The Gaussian function in OriginPro was applied to the selected peaks until converged, providing the peak position and full width at half-maximum (FWHM). Using Bragg’s law, as per Equation (8), the interplanar spacings for (002) and (110) were calculated [66]:

$${d}_{h k l} = \frac{λ}{2 \times s i n θ}$$

where λ is the wavelength of the incident X-ray (1.542 A°), θ is the angle of the incident beam, hkl are the Miller indices of a given Bragg plane.

Assigning Miller indices to the hexagonal closed packing (HCP) crystal structure, lattice parameters in (c) and (a) axes were calculated, as per Equation (9 - 11):

$$\frac{1}{{d}_{h k l}} = \frac{4}{3} \frac{\left({h}^{2} + h k + {k}^{2}\right)}{{a}^{2}} + \frac{{l}^{2}}{{c}^{2}}$$

$$c = l \times {d}_{002} ;$$

$$a = 2 \times {d}_{110} \sqrt{\frac{\left({h}^{2} + h k + {k}^{2}\right)}{3}}$$

The crystallite stacking height (L_{c}) and lateral size (Lₐ) were determined using the Scherrer equation, as shown in Equation (12 - 13) [67]:

$${L}_{c} = \frac{{k}_{s} \times λ}{{B}_{θ} \times c o s θ}$$

$${L}_{a} = \frac{1.84 \times λ}{{B}_{θ} \times c o s θ}$$

where, kₛ is the shape factor with 0.94 value used due to polycrystalline graphite, B_{θ} is the FWHM of the θ angle corrected for instrumental broadening using a silicon standard.

### Results

### Surface Area Evolution

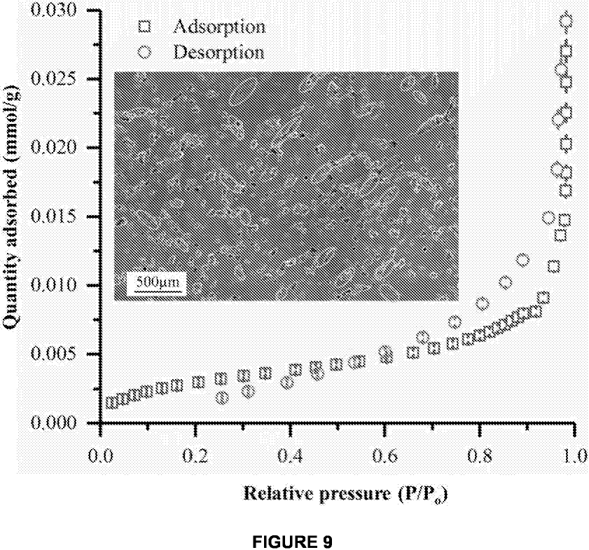

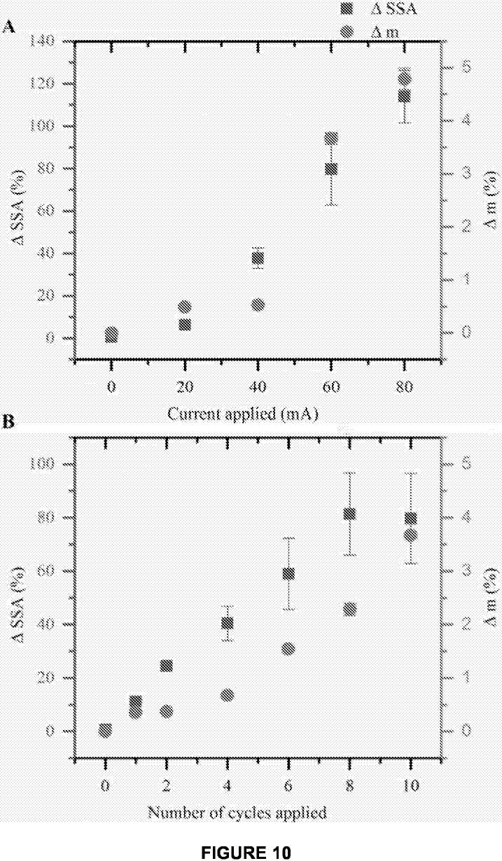

Adsorption of krypton at 77 K on the graphite surface was recorded, and the amount adsorbed per gram of sample was plotted as a function of the relative pressure (P/Po). An example of an average isotherm obtained for untreated irradiated graphite is shown in FIG. 9. According to the International Union of Pure and Applied Chemistry (IUPAC) classification, the isotherm line shape can be assigned to the type II physisorption isotherm with the closed H3 type of hysteresis loop [68]. This type of lineshape indicates samples are typically macroporous with plate-like particles enriched with slit-shaped pores and is consistent with the description of the analysed graphite grade and the observations made by SEM. The SSA for untreated samples were calculated by the combined BET-Rouquerol method (see Appendix E), providing the average value across the samples of 0.207 m²/g. To investigate the evolution of the graphite surface area that may be affected by current applied to the system during the decontamination treatment, analysis of SSA was performed on samples treated with a range of currents. FIG. 10A demonstrates the change of total SSA and mass of the sample as a function of the current value for the samples which had undergone ten cycles of electrochemical decontamination. At the lowest current (20 mA), an increase in the surface area was recorded (around 6%), suggesting a limited influence on the surface area and, therefore, it was excluded from the future investigation.

The highest currents (60 mA and 80 mA) however showed a change up to 120% increase in SSA from the initial value. A similar trend was revealed when analysing the influence of treatment cycle number on samples treated with a constant current of 60 mA (see FIG. 10B). Where negligible change occurred during the first two cycles, followed by a trend in the SSA change shows a steady increase, reaching a maximum of 80% gain from the initial value. This finding suggests that both the current and number of cycles have a substantial influence over the surface area to most likely provoke an irreversible change in surface area of the studied graphite samples.

### Surface Morphology

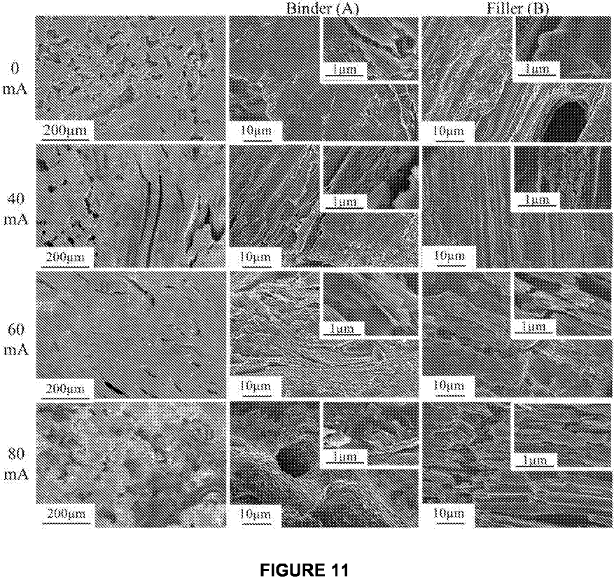

To better understand the evolution of graphite surface morphology under molten salt decontamination conditions, electron micrographs were collected from samples treated with ten cycles of electrolysis at 40, 60 and 80 mA current to compare with the previously recorded untreated structure of irradiated PGA graphite. A substantial number of pores present on the surface (see FIG. 11 for 0 mA) are caused by radiolytic oxidation during the operation process in the nuclear reactors, and sphere-shaped pores are formed during the manufacturing process by gas evolution [69]. That observation indicated that changes recorded in BET surface area analysis should occur evenly throughout the bulk of the material during the treatment.

As shown in FIG. 11 the graphite surface after 40 mA current had features typical of the untreated graphite with filler particles incorporated in a binder phase, considerable porosity and a chaotic random structure characteristic of an artificial graphite grade. It is evident that the molten salt treatment at lower currents did not alter the microstructure, with no significant differences observed in the sample morphology in comparison to the untreated irradiated sample. Examining the microstructure after treatment at higher currents (see FIG. 11 for 60 mA and 80 mA), the overall material matrix after the treatment exhibits the same structure with randomly oriented crystallites. That observation suggests that despite increased interactions between graphite and salt with an increase of current, filler particles were not subject to degradation under current molten salt treatment conditions. At the highest studied current of 80 mA, however, limited partial removal of the pitch binder and impregnant were observed. That change was demonstrated in the enlargement of the pores, leaving the filler particles isolated near the open pores and more evident.

### Chemical and Electronic State of Carbon on the Surface

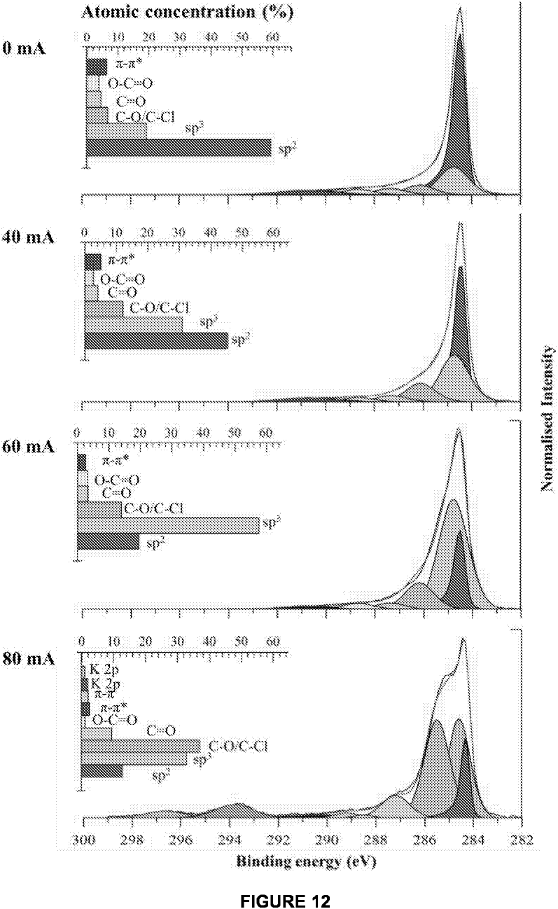

To understand if there is the preferential removal of sp³/sp² or both sp² and sp³, X-ray photoelectron spectroscopy (XPS) was performed, and the chemical and electronic state of carbon element present on the surface after molten salt treatment was identified. FIG. 12 shows the high-resolution C 1 s spectra performed on irradiated graphite treated with different currents, where 0 mA (untreated irradiated sample) was used as a reference to determine the molten salt treatment influence.

Using CASA XPS software [70], the data were analysed, starting with the subtraction of background with a Shirley lineshape. A detailed fitting analysis performed on C 1 s spectra showed the presence of six different carbon bonding states. The first peak, which represents the sp² aromatic configuration of carbon, was fitted using an Asymmetrical Lorentzian (AL) lineshape with the centre at 284.5 eV binding energy and a narrow full width at half-maximum (FWHM) (<1 eV) [71,72]. The second peak shifted by +0.3 eV arises from sp³ character and is analysed using a Gaussian-Lorentzian (GL) lineshape fitting with much broader FWHM (≈1.5 eV) [73,74].

The next three peaks identified on the surface were related to the carbon-oxygen bond. All peaks were fitted with symmetrical GL lineshape with equal area components and were shifted from the first peak by +1.7 eV, +2.9 eV, +4.2 eV for C—O, C═O and O—C═O respectively. The presence of these three groups is characteristic of graphite subjected to radiolytic oxidation. As all analysed samples were treated in the molten chloride salt, the presence of C—Cl bond could not be excluded.

Similar shifts between C—Cl and C—O bonds [74-76], however, make the definitive separation not obtainable and therefore two peaks were estimated as a joint one. The last peak represented by the π-π* level transition is shifted by +6.3 eV and fitted with a broad GL lineshape [73]. Once the peak areas for each of the above-mentioned carbon bonds were determined, the Scofield relative sensitivity factors [70] were used to determine the relative atomic percentages. The highest atomic concentration of around 60% in untreated graphite was allocated to aromatic carbon sp² bonds.

The analysis C 1 s peak fittings of samples treated with a set of currents revealed significant differences in atomic concentrations. Graphite treated at 40 mA showed a similar trend in peak distribution with the domination of an asymmetrical sp² peak. However, a small reduction of atomic concentrations for the sp² bond was observed. Analysis of the 60 mA current influence revealed the change of dominant peak in favour of the aliphatic carbon sp³ bond, while at 80 mA C—O/C—Cl dominated.

### Graphite Crystallinity and Structural Parameters

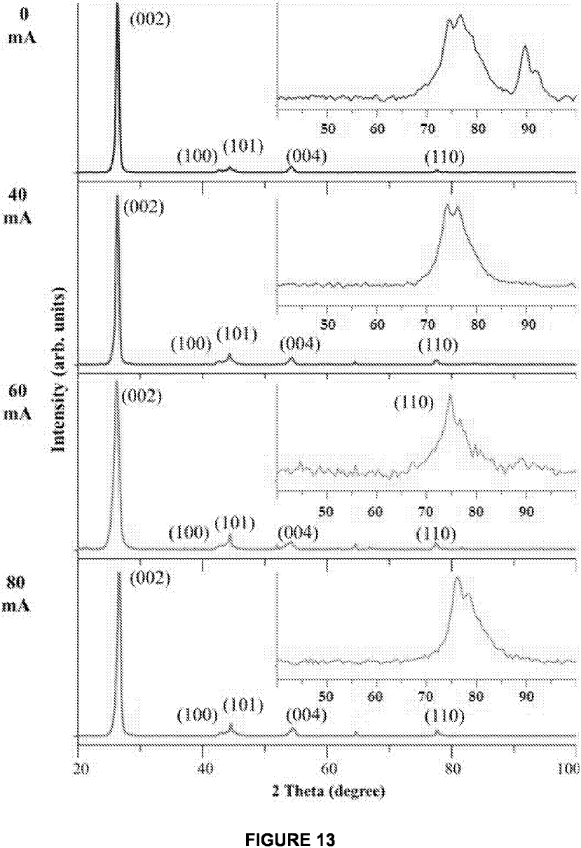

To gain a fundamental understanding of the effects of molten salts on graphite and, in particular, location-specific radioisotope removal, graphite crystallinity and structural parameters, sample post molten salt treatment were examined using X-ray diffraction (XRD). FIG. 13 shows the XRD patterns of graphite treated as a function of increased currents. The analysis of the pattern revealed the following reflections present in all of the samples: (002) (100), (101), (004) and (110).

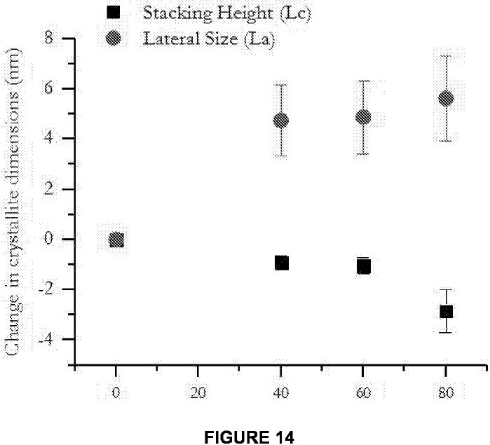

The results obtained for the crystallite parameter (c) and stacking height (L_{c}) determined by the Scherrer method are in Table 2, and to evaluate the influence of molten salt treatment, the parameters for the untreated irradiated sample was used as a reference. It may be seen that the spacing corresponding to the (002) peak after the treatment cycles remained identical to that obtained for 0 mA, with the almost identical value received for 40 mA current and a small fluctuation for the higher currents (60 mA and 80 mA). Nevertheless, a small decrease from 15.64 nm to 12.79 nm in stacking height (L_{c}) was recorded. This observation corresponds to an increase in lattice disordering and may be influenced by the rise in salt interaction during the electrolysis at the higher current settings. Crystallite parameters (a) and lateral sizes (Lₐ) obtained by mentioned in Section 5.2.2 method for the set of currents are presented in Table 3. The value of the (a) parameter with the increase of current remains unchanged from untreated graphite (0 mA). However, the results for lateral size (Lₐ) showed a slight uprising trend with a growth from 37.42 nm to 43.04 nm. The overall change in crystallite dimensions as a function of current is presented in FIG. 14, providing a maximum of 6 nm shift in lateral size (Lₐ).

TABLE 2

Structural characteristics estimated using XRD pattern analysis of the (002) reflection of irradiated PGA graphite treated with different currents. All samples underwent ten cycles of treatment

| Current, mA | 2 θ (°) | d₍₀₀₂₎ (nm) | c (nm) | Bθ (radian) | L_{c} (nm) | $\frac{{L}_{c}}{{d}_{\left(002\right)}}$ |
|---|---|---|---|---|---|---|
| 0 | 26.37 | 0.3380 | 0.6760 | 0.0095 | 15.64 | 46.28 |
| 40 | 26.35 | 0.3383 | 0.6766 | 0.0101 | 14.73 | 43.55 |
| 60 | 26.21 | 0.3400 | 0.6800 | 0.0102 | 14.61 | 42.97 |
| 80 | 26.60 | 0.3352 | 0.6704 | 0.0116 | 12.79 | 38.16 |

TABLE 3

Structural characteristics estimated using XRD pattern analysis of the (110) reflection of irradiated PGA graphite treated with a set of currents. All samples underwent ten cycles of treatment

| Current, mA | 2 θ (°) | d ₍₁₁₀₎ (nm) | a (nm) | B_{θ} (radian) | Lₐ (nm) | $\frac{{L}_{a}}{{d}_{\left(110\right)}}$ |
|---|---|---|---|---|---|---|
| 0 | 77.66 | 0.1230 | 0.2459 | 0.0103 | 37.42 | 304.32 |
| 40 | 77.57 | 0.1231 | 0.2462 | 0.0091 | 42.17 | 342.58 |
| 60 | 77.52 | 0.1232 | 0.2463 | 0.0091 | 42.29 | 343.42 |
| 80 | 77.74 | 0.1229 | 0.2457 | 0.0089 | 43.04 | 350.31 |

### Discussion

The evolution of irradiated PGA graphite microstructure under molten salt decontamination conditions was investigated using multi-technique characterisation to extensively understand the material behaviour and structural changes under these conditions. Results show limited degradation of graphite microstructure under the conditions of maximum current (80 mA) and cycle number (10). The degradation that was observed was predominantly associated with enlargement of surface area due to deterioration of binder and impregnant phase. The influence of electrochemical decontamination on graphite microstructure and the impact on the surface area and morphology, as well as on chemical and electronic state of carbon on the surface and surface crystallinity and structural parameters will be discussed in detail below.

### Impact on Surface Area

Recent comprehensive porosity studies [69,77] showed a range of hundreds of nanometers up to micrometres could be found in the same graphite grade as well as a wide variety in shape and orientation [78-80]. Furthermore, Banares-Munoz et al. [81] reported the dependence of the specific surface area on different nuclear graphite grades, indicating the influence of crystallinity on that trend with larger areas detected for artificial graphite. The most common mechanisms of surface change are due to porosity creation related to gas trapping, shrinkage, coalescence or expansion of existing pores [82,83]. The change in surface area with the increase of the number of cycles suggests that process such as salt infiltration into the porous system could also be associated with this change. Herein, several factors such as capillary pressure inside the graphite pore and the pressure difference created between the molten salt meniscus should be taken into account [84]. This mechanism can be supported by evidence of thin wall destruction under elastic compression, where the rise of current could accelerate electrochemical gradient and create a significant motive force. That additional influence could force the opening of a closed pore in the bulk of the material, leading to the enlargement of the surface area in the specimens observed after treatment. A similar process was reported by Dickson and Shore [85] during mercury porosimetry measurements of graphite material.

### Impact on Surface Morphology

Pile Grade A graphite selected for current studies represents a complex polycrystalline structure with a mixed morphology of micro (<2 nm) and macro (>50 nm) pores. Due to the irregularity of graphite pores [86], the difference in response to electrochemical treatment could be significant even on the surface of a small specimen. In previous studies of oxidation effects on nuclear graphite microstructure [12,87-89], the filler particles were reported to be more stable compared to binder or impregnant. The difference lies in the nature of the particles with the filler being a product of coke calcination, while binder and impregnant have less ordered structures and, therefore, less energy is required to start the oxidation process. It was also outlined by Zheng et al. [90] that the preferable extension of cracks should be along the grain boundaries, which are represented in a graphite sample as boundaries between filler and binder phases. The presence of metallic particles could also accelerate the oxidation process in the presence of oxygen, as has been highlighted by Contescu et al. [89]. Therefore the general trend shown in SEM observations of current influence on the surface morphology is in good agreement with previously reported trends for nuclear graphite microstructure.

According to previous research by Contescu et al. [91], at the temperature range of 873-923 K processes on the surface of graphite caused by diffusion and/or sorption could be escalated and therefore result in the opening of new pores and pore enlargement. Similar effects were also reported for graphite materials used in the electrochemical studies [39,92]. Subsequently, the observed evolution of microstructure in this research is in accordance with previous studies. Another explanation to limited changes observed may be provided using the concept of an interconnected pore network reported previously by Laudone et al. [93]. According to this theory, the throat like pores would be affected first, provoking the coalescence of existing pores. In previous studies, it was shown that the distribution of molten salt in porous media such as graphite is expected to be uniform due to the concept of percolation theory [84].

Moreover, from studies on nanoscale carbon materials [94-96], it is well documented that a graphite electrode in molten chloride salt could be used to produce nanoscale carbon materials through electrolysis. It was emphasised by Schwandt et al. [97] that the process could be optimised by the regular change in polarity of the electrochemical system. The presence of metallic impurities or contamination, however, may cause the delay in nanoscale carbon formation, and this research suggests why a significant number of cycles required to observe a change in surface area and morphology.

### Impact on Chemical and Electronic State of Carbon on the Surface

Studies by El-Genk and Tournier [13] emphasised the role of edge sites of graphite planes in the oxidation process, where a one-atom thick layer of carbon with an unpaired electron becomes more reactive and therefore more susceptible to oxidation. A similar trend was noticed during the electrochemical studies of a single-layer graphene sheet [98] with excellent electrocatalytic properties reported for the edge site. The substantial decrease observed in atomic concentration of sp² bonded C atoms at increased current value represents the presence of dangling bonds and promotes the connection with functional groups present in the system (e.g. C═O, O—C═O) [98]. This is consistent with the growth of the peak in the XPS spectra, shown in FIG. 12, corresponding to the C—O/C—Cl bond, with increasing current. Adsorbed oxygen released from the pores during electrochemical treatment leads to accumulation of oxygen-containing groups on the graphite surface and could also add complexity to determining the mechanism. This is supported by previous studies [13,99,100] of graphite oxidation at low temperatures (<873 K) which revealed that oxygen could weaken the graphite microstructure due to the change in bonding between edge carbon and oxygen adsorbed on its surface. From the electrochemical studies [101] it is also known that during electrolysis ionised carbonate can decompose into oxygen and carbon. Furthermore, the substantial rise in atomic concentration for the C—O/C—CI peak observed in XPS spectra at 80 mA current could indicate significant formation of C—Cl compounds. A similar trend was reported previously by Bousa et al. [75] during the chlorination of graphene and by Tian et al. [102] during the electrolysis in fluoride salt, where the significant formation of C—F compound on the surface of graphite electrode was observed.

### Impact on Surface Crystallinity and Structural Parameters

PGA graphite generally shows anisotropic features due to the nature of petroleum coke and extrusion route used for its manufacturing [32]. Under reactor neutron irradiation conditions, however, microstructural defects such as vacancies and interstitial atoms may be formed [103], resulting in broadening and shifting of peaks on XRD patterns. A recent study [104] identified a proportional increase in lattice parameter (c) under neutron irradiation conditions with the significant influence from both dose and temperature. That is consistent with the initial values of lattice parameters of untreated graphite.

The degradation of graphite materials exposed to molten salt was reported previously [105-107]. One of the primary mechanisms identified was the formation of intercalated compounds. Based on the analysis of peaks for the corresponding (002) and (110) reflections, no substantial changes to the lattice parameters were observed. The limited variation in crystalline dimensions revealed a non-intercalation mechanism is behind the molten salt decontamination process. Although the understanding of the particular mechanism of graphite decontamination remains under investigation, the stability of crystalline parameters for graphite pre- and post-treatment is one of the crucial findings for possibly developing this method to deliver graphite that can be reused in nuclear industry as these parameters determine the mechanical, electrical and thermal properties of graphite [108-111].

### Conclusions

The evolution of irradiated graphite microstructure under molten salt decontamination conditions has been performed, and irradiated PGA graphite behaviour and structural changes under these conditions were assessed using advanced multi-technique characterisation.

This research shows that the magnitude of applied current and the number of electrochemical treatment cycles provided the most significant impact on the enlargement of graphite specific surface area. The research revealed these changes are mainly associated with moderate alterations to the binder and impregnant phases, leaving the filler particles intact even under extreme conditions of treatment (maximum current and cycle number). The assessment of the chemical state of the sample surface analysis shows significant differences in atomic concentrations of C 1 s deconvoluted peaks, suggesting the mechanism involves diffusion of pre-adsorbed oxygen in pores in combination with limited chlorination of the surface. The stability of lattice parameters pre and post-treatment combined with limited change in crystalline dimensions indicates no intercalation from molten salt.

Such findings uncover promising potential for irradiated graphite to be decontaminated and the mechanism behind the electrochemical decontamination of irradiated graphite material. Future work will explore the evolution of mechanical properties under these conditions and whether similar microstructural changes can be observed in further graphite grades.

### APPENDICES FOR PART 2

### Appendix E

### Supplementary Data for the Specific Surface Area Analysis

TABLE E.1

The summary data of samples used in specific surface areas (SSA) analysis

| | | | | | | | | | |
|---|---|---|---|---|---|---|---|---|---|
| N° | Sample ID* | Current, mA | Cycle No | m before, g | m after, g | Δm % | SSA _{before} m²/g | SSA _{after} m²/g | Δ SSA % |
| 1 | S_7 | 60 | 1 | 0.235 | 0.235 | 0.13 | 0.195 | 0.212 | 8.5 |
| 2 | W_5 | 60 | 1 | 0.449 | 0.446 | 0.58 | 0.351 | 0.406 | 15.9 |
| 3 | S_8 | 60 | 2 | 0.488 | 0.486 | 0.45 | 0.158 | 0.209 | 32.6 |
| 4 | W_4 | 60 | 2 | 0.587 | 0.586 | 0.29 | 0.209 | 0.26 | 24.5 |
| 5 | O_7 | 60 | 4 | 0.469 | 0.464 | 1 | 0.241 | 0.362 | 50.4 |
| 6 | W_6 | 60 | 4 | 0.498 | 0.497 | 0.34 | 0.161 | 0.238 | 47.3 |
| 7 | O_8 | 60 | 6 | 0.457 | 0.452 | 1.29 | 0.271 | 0.461 | 70 |
| 8 | W_7 | 60 | 6 | 0.265 | 0.26 | 1.77 | 0.235 | 0.415 | 76.7 |
| 9 | W_10 | 60 | 8 | 0.459 | 0.448 | 2.51 | 0.185 | 0.395 | 113.6 |
| 10 | W_8 | 60 | 8 | 0.217 | 0.213 | 2.03 | 0.241 | 0.473 | 96.2 |
| 11 | S_10 | 0 | 10 | 0.458 | 0.458 | 0 | 0.185 | 0.186 | 0.6 |
| 12 | S_9 | 0 | 10 | 0.238 | 0.238 | 0 | 0.124 | 0.125 | 0.7 |
| 13 | O_4 | 20 | 10 | 0.487 | 0.485 | 0.45 | 0.134 | 0.142 | 5.6 |
| 14 | S_4 | 20 | 10 | 0.616 | 0.613 | 0.52 | 0.232 | 0.249 | 7.5 |
| 15 | O_3 | 40 | 10 | 0.232 | 0.228 | 1.51 | 0.152 | 0.222 | 46.2 |
| 16 | S_5 | 40 | 10 | 0.6 | 0.595 | 0.8 | 0.23 | 0.325 | 41.7 |
| 17 | O_9 | 60 | 10 | 0.401 | 0.386 | 3.81 | 0.241 | 0.491 | 103.9 |
| 18 | W_9 | 60 | 10 | 0.491 | 0.472 | 3.91 | 0.158 | 0.354 | 124.4 |
| 19 | O_6 | 80 | 10 | 0.384 | 0.365 | 4.93 | 0.138 | 0.373 | 169.5 |
| 20 | S_6 | 80 | 10 | 0.315 | 0.301 | 4.45 | 0.291 | 0.699 | 140.1 |
| * | | | | | | | | | |

* - O - Oldbury Magnox reactor, S - Sizewell Magnox reactor, W - Wylfa Magnox reactor

### Part 3 - Off-Gas Release of Tritium and Carbon-14 From PGA Graphite During Electrochemical Decontamination in LiCl—KCl

In this study, a primary assessment the off-gas release associated with ³H and ¹⁴C under these conditions (up to 80 mA in absolute magnitude of current and up to 10 cycles of switching between positive and negative current application) was explored. This research shows that a significant release of ³H (up to 50%) can be achieved by adjusting the treatment conditions. The assessment of ¹⁴C release, in contrast, showed limited release (up to 15%). These results have provided the foundation for understanding the mechanisms of ³H and ¹⁴C release from the irradiated graphite due to electrolysis in a molten salt system.

### Experimental

### Materials

Irradiated Pile Grade A (PGA) nuclear graphite, irradiated to ~6 dpa and ~543 K, was used in the current studies. The samples were retrieved from Oldbury, Wylfa and Sizewell Magnox reactor sites in the UK by trepanning a cylinder of 12 mm in diameter from the bulk moderator material, followed by cutting to achieve 6 mm length of the samples. Samples were sliced in half across the width and washed with acetone to remove any loose surface contamination.

### Treatment and Activity Release Analysis

Samples were treated under an Ar atmosphere in LiCl—KCl eutectic at 723 K with a range of electrical currents (up to 80 mA) and a number of electrochemical cycles (up to 10). For the purpose of this study, the electrochemical treatment with the application of combined negative and positive currents for a total duration of five hours is referred to as one electrochemical cycle.

The gases released during the molten salt treatment, ³H and ¹⁴C, were captured with trap solutions in a chain of bubblers placed at the gas outlet of the electrochemical cell. The first two bubblers were filled with 20 ml of 1 M HNO₃ to capture ³H, then followed by two bubblers allocated to capture ¹⁴C release in the form of CO₂ with 40 ml Carbon Trap (99% 3-methoxypropylamine). Based on previously established work [10], the assumption was made that all released ¹⁴C was in CO₂ form. Once the molten salt treatment was concluded, the liquids from the bubblers were analysed using a TRI-CARB 3100TR Liquid Scintillation Counter by a previously established method [112].

Due to the concern over the inhomogeneous distribution of ³H and ¹⁴C across the samples, the total specific activity of these isotopes in each sample was determined by full oxidation of the graphite post-treatment. The full oxidation was conducted at 1273 K in air by a previously described method [113]. The ³H and ¹⁴C from the fully oxidised graphite samples were captured and analysed as described above. The release associated with molten salt treatment was determined as a percent of the total activity for each sample individually and for the applied current studies was estimated across two analysed samples.

The analysis of released activity for the influence of cycle number studies was conducted continuously on a sample with a new set of bubblers introduced at the beginning of every cycle. The system was stopped at 1, 2 and 4 and 10 cycles. When stopped, a graphite sample was extracted from the system, cleaned and analysed.

### Results

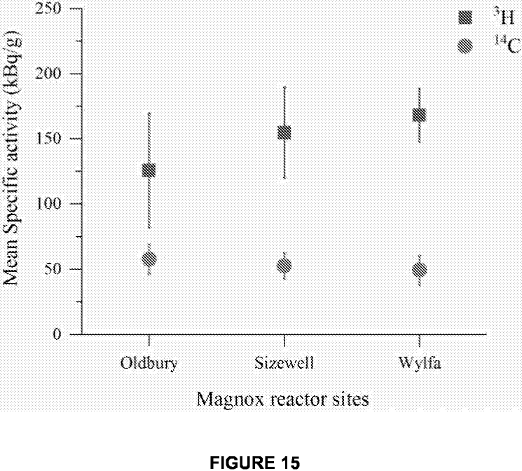

The inventory of mean specific activity for ³H and ¹⁴C was estimated across 11 samples from different Magnox reactor sites and presented in FIG. 15 (individual values of activity for each sample are present in Appendix F and Appendix G). Variable specific activities of ³H and ¹⁴C observed across graphite samples extracted from different reactor sites have provided the opportunity to understand the influence of molten salt decontamination conditions on ³H and ¹⁴C release in connection with variable initial concentrations.

The investigation into the influence of the absolute magnitude of current passed through the system on the release of activity into off-gas phase was conducted using graphite samples sourced from different sites (see Appendix F).

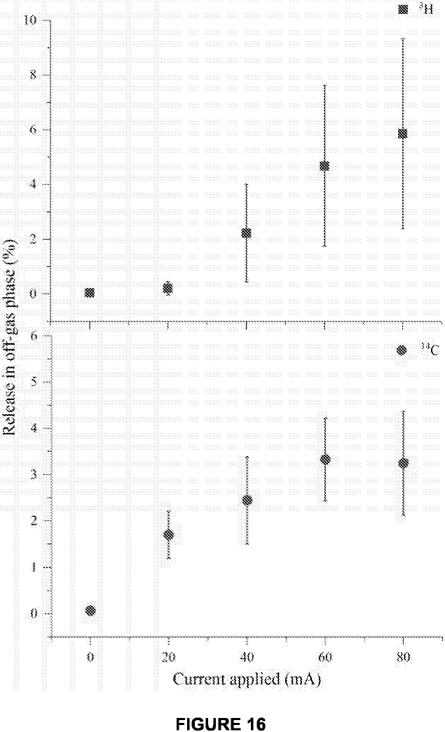

The averaged, across two samples at the same treatment conditions, release of ³H and ¹⁴C was determined after one cycle of molten salt treatment and analysed as a function of current (see FIG. 16) The revealed trend for ³H release showed an almost linear increase with increasing current. Still, the overall magnitude of ³H release under these conditions reaches no more than 10%, and the relative errors for these release data are quite large. For ¹⁴C release, it was found that the magnitude of current did not appear to contribute significantly to release of this radioisotope showing fluctuating behaviour and achieving no more than 3% release at the highest current value (80 mA).

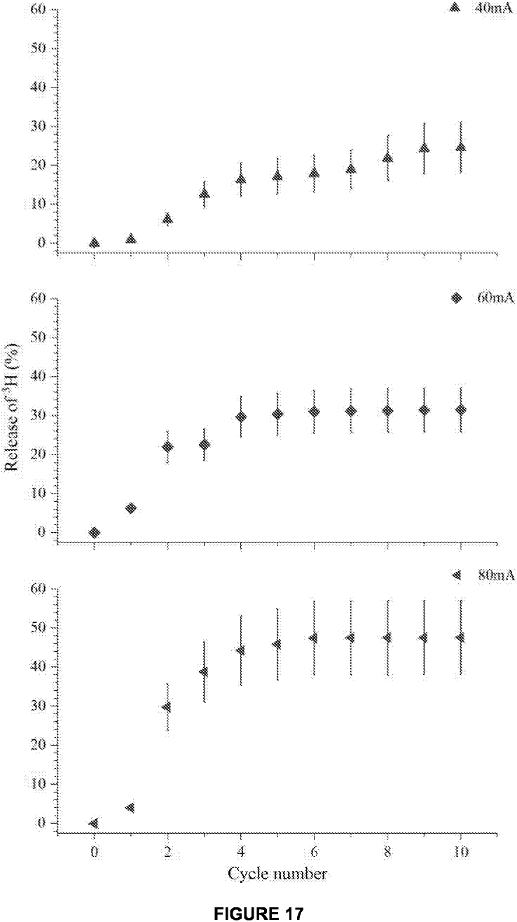

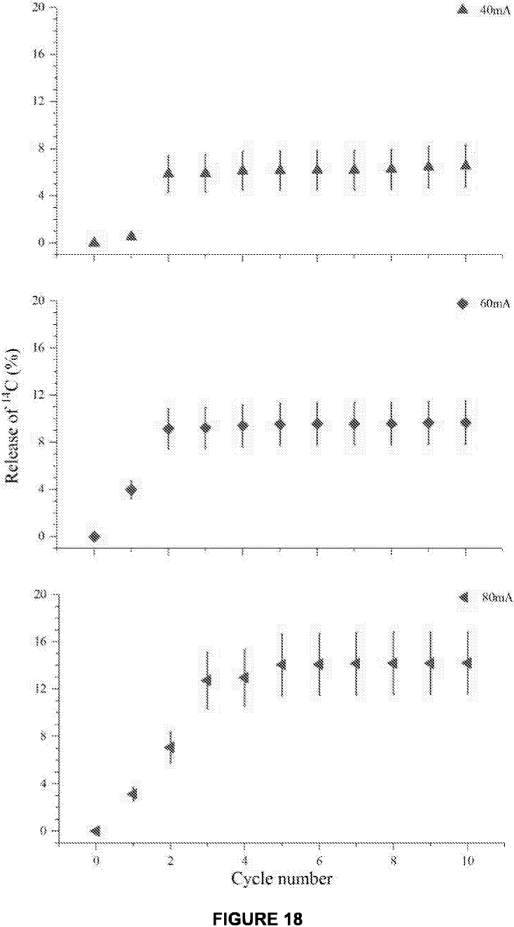

The influence of the electrochemical cycles (switching between negative and positive currents of absolute magnitude) was assessed to understand the behaviour of ³H and ¹⁴C under these conditions. The analysis was conducted under various currents (40 mA, 60 mA and 80 mA) and applied up to 10 cycles. The same samples were used to assess the continuous release of ³H and ¹⁴C obtained as a function of cycle number (see Appendix B). The results for ³H and ¹⁴C release during this investigation analysed using one sample for each condition is presented in FIG. 17 and FIG. 18, respectively.

The results for ³H release from the graphite during the treatment at 40 mA current show a steady linear rise in relative amount of ³H detected in off-gas phase with the increase in cycle number up to 5 cycles. Further cycles only gave a slight rise in ³H release, with a maximum of 25% total ³H release achieved. For 60 mA current, similar linear increase in the amount of released ³H detected up to 4 cycles of treatment, followed by consecutive small releases until the end of the investigation, to approximately 30% total ³H release. When using 80 mA current, a steep increase was found in radioisotope transfer into the gas phase with increasing cycle number up to cycle 4, achieving almost 45% ³H release from graphite. The further increase in cycle number, however, did not impact on the release of ³H showing no significant release in the off-gas phase.

¹⁴C showed similar trends for corresponding currents with an increase in release observed in up to 4 cycles of treatment. The analysis of overall activity detected in the off-gas phase for ¹⁴C showed the gradual increase in release of this radioisotope from graphite with the increase of current over an extended number of cycles resulting in 6, 10 and 14% for 40 mA, 60 mA and 80 mA, respectively.

The analysis of ³H and ¹⁴C presence in the salt phase was conducted at the end of the cycling procedure, and negligible amounts of both radioisotopes were present. According to the observed trends, the most significant impact on the overall release of radioisotopes in the off-gas phase for the analysed graphite samples can be expected from the applied current. Moreover, for graphite samples with the same specific activity, the majority of off-gas release may be expected by the end of 4 cycles of electrochemical treatment at 80 mA current.

### Discussion

The release of radioisotopes in off-gas phase due to electrochemical decontamination of irradiated PGA graphite in a molten salt system was investigated to understand the behaviour of ³H and ¹⁴C under these conditions. Results show that even though this molten salt treatment was primarily explored for release of corrosion and fission products from graphite; this method can successfully reduce ³H present in irradiated PGA graphite, up to 50%, with the most important parameter for efficient release being the magnitude of the applied current. In contrast, only a limited release in ¹⁴C, up to 15%, was achieved by this approach. The difference in the behaviour of the release observed for ³H and ¹⁴C may be associated with the different nature of these graphite contaminants, which will be discussed in details below.

### Release of ³H

The capture mechanism of ³H initially proposed by Kanashenko et al. [114] and further developed by Atsumi et al. [115,116] includes three main stages of ³H trapping inside the graphite material. During the diffusion through the bulk of the material, the radioisotope could be absorbed by the internal porosity, where it can be either trapped at the edge of a crystallite or by further grain boundary diffusion could end in an interstitial cluster loop [115,116]. Therefore, the multi-step process associated with each type of trapped ³H could be expected during the thermal treatment. Due to the considerable energy required to release ³H trapped in interstitial cluster loops, ³H would initially be released from a near-surface layer via a desorption mechanism, followed by release via a de-trapping mechanism from the crystalline edges and then from the cluster loops. If the energy level is not sufficient enough to promote the de-trapping, a slowdown in the release rate could be observed. During the extended number of cycles in the current studies, a slowdown in ³H release was observed, showing that the obtained data are in good agreement with the discussed model of ³H behaviour. According to the described mechanism of ³H release, an increase in current/temperature of the treatment would significantly promote ³H release. According to the studies conducted by Le Guillou et al. [117] on tritium behaviour in a gas-cooled reactor at ca. 1473 - 1573 K the majority of trapped tritium could be released. Katayama et al. [118], however, when studying ³H release behaviour from graphite tiles reported limited release in dry Ar at 1473 K over 13 hours, with a significant response to the addition of 1% of oxygen to the carrier gas, which increased the total release by a factor of 3 over the following hour of treatment accompanied by a significant degradation of graphite material (0.36 g/h).

The behaviour of graphite layers during electrochemical treatment, however, could significantly impact on the release of ³H. As reported by Simonet et al. [39] a graphite matrix during the electrolysis can accept electrons on its surface, accommodating a particular level of charge. When such a charge forms near the surface, it will attract cations from salt to neutralise it, therefore acting as a chemical reducing agent. That can end in a weakening of the bond between the graphite layers and release the trapped ³H.

### Release of ¹⁴C

The production routes of ¹⁴C in a graphite matrix under neutron irradiation have been widely studied, and two most preferable pathways for ¹⁴C formation were identified. According to several sources [16,18], activation of ¹⁴N adsorbed on graphite surface is considered as one of the primary routes due to its relatively high neutron absorption cross-section, leading to inhomogeneous distribution inside graphite. In addition, the activation of naturally abundant ¹³C in the graphite leading to a homogeneous distribution of ¹⁴C across the graphite system has also been supported in several cases [28,119,120]. Given the lack of certainty on the mechanism of ¹⁴C formation in irradiated graphite, the process of selective ¹⁴C release from graphite without the destruction of material is one of the most challenging.

The molten salt treatment presented in this study was conducted at 723 K, in temperature range associated with the chemical oxidation regime for graphite, where the primary mechanism is the diffusion of oxygen through the open pore system [11].

For studies exploring deploying of a number of cycles, ¹⁴C showed a small initial response with a more evident increase, followed by levelling out towards a maximum ¹⁴C release level. That was most likely due to the limited presence of oxygen in the system presented by pre-adsorbed species [120]. A similar trend was observed during the thermal treatment of a similar graphite grade [18] under nitrogen atmosphere at 1373 K, which indicated that an increase in temperature would show no improvement in radioisotope release.

An increase in ¹⁴C release was observed when the sample was moved from the system and exposed to air while preparing for further analysis. That may have provided the additional supply of oxygen to the active edge site of the graphite structure, and this fresh oxygen would have reacted with the graphite surface when it was returned to high temperature in molten salt, releasing more ¹⁴C local to the surface. Moreover, the observed increase in the surface area of samples combined with the increase in carbon-oxygen bonding on the surface observed during the previous analysis may have resulted in a significant increase of available active edge sites in the graphite structure, and, therefore, that may explain the observed trend during the extended number of cycles. The significance of oxygen presence on release has also been highlighted during previous studies [16,21,113,121], where the addition of 1% oxygen magnified the observed release of ¹⁴C without the significant destruction of material.

The additional factor in the current research, which could impact on the release of ¹⁴C is an electrochemical force. The implementation of current could create an electrochemical gradient and therefore a significant motive force, provoking the opening of a closed pore in the bulk of the material, leading to the further access to the oxygen species present in the graphite matrix [34].

The partial release of ³H and ¹⁴C observed in this study provides a foundation for understanding the formation and location of these isotopes in irradiated graphite. Electrolysis in a molten salt system may be readily adapted to explore improving the levels of ³H and ¹⁴C removal from graphite observed in this study and requires further investigation.

### Conclusions

An investigation on the release of ³H and ¹⁴C from irradiated PGA graphite during electrochemical decontamination in molten salt has been performed. The influence of the various treatment conditions on the release of these radioisotopes in the off-gas phase has been analysed using liquid scintillation counting.

This study shows that a significant release of ³H (up to 50%) may be achieved by adjusting the treatment conditions. The magnitude of the applied current is found to be an influencing factor, and the evidence suggests that with the increase of this parameter, a further release of activity associated with ³H may be achieved. The assessment of the ¹⁴C release, however, showed limited release (up to 15%) associated with insignificant degradation of material. The current investigation suggests that an improvement in the release of ¹⁴C could be achieved by the implementation of a limited supply of oxygen.

Future work will explore whether the proposed electrochemical method of graphite decontamination in molten salt seen to be successful for the release of metallic radioactive impurities, may be further adapted to improve the release of ³H and ¹⁴C from graphite. Future work will also involve the assessment of off-gas release for graphite other than PGA, and whether this process can be scaled up to meet industrial capacity.

### APPENDICES FOR PART 3

### Appendix F

### Supplementary Data for the Influence of an Applied Current

TABLE F.1

Change in specific activity of ³H and ¹⁴C in graphite after electrochemical treatment (up to 80 mA, 1 cycle) in LiCl—KCl eutectic at 723 K

| No | Sample ID | Current, mA | Cycle No | m before, g | m after g | Isotope | A total kBq/g | A released kBq/g |
|---|---|---|---|---|---|---|---|---|
| 1 | O_4 | 20 | 1 | 0.487 | 0.487 | ³H | 157.31 | 0.70 |
| | | | | | | ¹⁴C | 55.26 | 0.83 |
| 2 | S_4 | 20 | 1 | 0.616 | 0.616 | ³H | 156.95 | 0.06 |
| | | | | | | ¹⁴C | 52.04 | 1.14 |
| 3 | O_3 | 40 | 1 | 0.232 | 0.232 | ³H | 123.02 | 4.93 |
| | | | | | | ¹⁴C | 63.39 | 2.14 |
| 4 | S_5 | 40 | 1 | 0.600 | 0.600 | ³H | 133.25 | 2.32 |
| | | | | | | ¹⁴C | 39.19 | 0.47 |
| 5 | O_5 | 60 | 1 | 0.380 | 0.380 | ³H | 90.10 | 6.86 |
| | | | | | | ¹⁴C | 66.98 | 1.63 |
| 6 | W_4 | 60 | 1 | 0.5872 | 0.5872 | ³H | 177.98 | 7.91 |
| | | | | | | ¹⁴C | 46.66 | 2.04 |
| 7 | O_6 | 80 | 1 | 0.384 | 0.384 | ³H | 79.46 | 7.42 |
| | | | | | | ¹⁴C | 69.59 | 1.48 |
| 8 | S_6 | 80 | 1 | 0.315 | 0.315 | ³H | 109.25 | 4.40 |
| | | | | | | ¹⁴C | 39.13 | 1.23 |

* - O - Oldbury Magnox reactor, S - Sizewell Magnox reactor, W - Wylfa Magnox reactor

### Appendix G

### Supplementary Data for the Influence of an Applied Current and Cycles

TABLE G.1

Change in specific activity of ³H and ¹⁴C in graphite after electrochemical treatment (up to 80 mA, up to 10 cycles) in LiCl—KCl eutectic at 723 K

| No | Sample ID | Current, mA | A ᵢₙᵢₜᵢₐₗ | | Cycle No | Released ³H Bq/g | Released ¹⁴C Bq/g |
|---|---|---|---|---|---|---|---|
| | | | ³H, kBq/g | ¹⁴C, kBq/g | | | |
| 1 | S_3 | 40 | 162.94 | 37.01 | 1 | 1529.39 | 19.32 |
| | | | | | 2 | 8514.43 | 188.57 |
| | | | | | 3 | 10462.83 | 1.62 |
| | | | | | 4 | 6090.46 | 7.28 |
| | | | | | 5 | 1455.17 | 0.64 |
| | | | | | 6 | 1242.39 | 1.41 |
| | | | | | 7 | 1657.72 | 0.47 |
| | | | | | 8 | 4680.89 | 2.62 |
| | | | | | 9 | 4019.34 | 6.92 |
| | | | | | 10 | 493.06 | 2.52 |
| 1 | W_10 | 60 | 187.16 | 44.10 | 1 | 11782.11 | 1762.62 |
| | | | | | 2 | 29318.17 | 2267.20 |
| | | | | | 3 | 1140.09 | 36.30 |
| | | | | | 4 | 13119.37 | 79.84 |
| | | | | | 5 | 1441.21 | 45.21 |
| | | | | | 6 | 1140.11 | 18.66 |
| | | | | | 7 | 428.66 | 3.04 |
| | | | | | 8 | 169.54 | 4.57 |
| | | | | | 9 | 145.34 | 27.36 |
| | | | | | 10 | 160.97 | 5.20 |
| 1 | S_6 | 80 | 109.25 | 39.13 | 1 | 4397.18 | 1232.77 |
| | | | | | 2 | 28098.16 | 1540.38 |
| | | | | | 3 | 9874.03 | 2213.47 |
| | | | | | 4 | 5924.76 | 92.37 |
| | | | | | 5 | 1779.96 | 430.06 |
| | | | | | 6 | 1774.33 | 6.60 |
| | | | | | 7 | 38.76 | 25.56 |
| | | | | | 8 | 30.53 | 5.37 |
| | | | | | 9 | 31.52 | 4.77 |
| | | | | | 10 | 41.75 | 10.18 |

* - O - Oldbury Magnox reactor, S - Sizewell Magnox reactor, W - Wylfa Magnox reactor

### REFERENCES

R. Nightingale, Nuclear Graphite, Academic Press, 2013. https://doi.org/10.1016/B978-1-4832-2854-9.50019-5.
B.J. Marsden, G. Hall, Graphite in Gas-Cooled Reactors, in: Ref. Modul. Mater. Sci. Mater. Eng., Elsevier, 2016. https://doi.org/10.1016/B978-0-12-803581-8.00729-3.
A. Wareing, L. Abrahamsen-Mills, L. Fowler, M. Grave, R. Jarvis, M. Metcalfe, S. Norris, A.W. Banford, Development of integrated waste management options for irradiated graphite, Nucl. Eng. Technol. 49 (2017) 1010-1018. https://doi.org/10.1016/j.net.2017.03.001.
M.P. Metcalfe, R.W. Mills, Radiocarbon mass balance for a Magnox nuclear power station, Ann. Nucl. Energy. 75 (2015) 665-671. https://doi.org/10.1016/j.anucene.2014.08.071.
Nuclear Decommissioning Authority, Higher Activity Waste: Strategic Position Paper on the Management of Waste Graphite, (2014) 1-21. https://assets.publishing.service.gov.uk/government/uploads/system/uploads/attachment da ta/file/457089/Strategic_position_paper on the_management_of waste_graphite.pdf (accessed Jul. 20, 2018).
Nuclear Decommissioning Authority, Geological Disposal Review of baseline assumptions regarding disposal of core graphite in a geological disposal facility, 2012.
Nuclear Decommissioning Authority, Integrated Waste Management NDA Higher Activity Waste Strategy NDA Higher Activity Waste Strategy, 2016. https://assets.publishing.service.gov.uk/government/uploads/system/uploads/attachment da ta/file/522435/NDA_Higher Activity_Waste_Strategy_2016.pdf (accessed Jul. 20, 2018).
M.S. El-Genk, J.M.P. Tournier, C.I. Contescu, Chemical kinetics parameters and model validation for the gasification of PCEA nuclear graphite, J. Nucl. Mater. 444 (2014) 112-128. https://doi.org/10.1016/j.jnucmat.2013.09.031.
M.S. El-Genk, J.M.P. Tournier, Validation of gasification model for NBG-18 nuclear graphite, Nucl. Eng. Des. 250 (2012) 142-155. https://doi.org/10.1016/j.nucengdes.2012.05.016.
S.G. Chen, R.T. Yang, F. Kapteijn, J.A. Moulijn, A New Surface Oxygen Complex on Carbon: Toward a Unified Mechanism for Carbon Gasification Reactions, Ind. Eng. Chem. Res. 32 (1993) 2835-2840. https://doi.org/10.1021/ie00023a054.
A. Theodosiou, A.N. Jones, B.J. Marsden, Thermal oxidation of nuclear graphite: A large scale waste treatment option, PLoS One. 12 (2017) e0182860. https://doi.org/10.1371/journal.pone.0182860.
L. Payne, P.J. Heard, T.B. Scott, A study of the oxidation behaviour of pile grade A (PGA) nuclear graphite using thermogravimetric analysis (TGA), scanning electron microscopy (SEM) and x-ray tomography (XRT), PLoS One. 10 (2015) e0143041. https://doi.org/10.1371/journal.pone.0143041.
M.S. El-Genk, J.M.P. Tournier, Development and validation of a model for the chemical kinetics of graphite oxidation, J. Nucl. Mater. 411 (2011) 193-207. https://doi.org/10.1016/j.jnucmat.2011.01.129.
M.S. El-Genk, J.M.P. Tournier, Comparison of oxidation model predictions with gasification data of IG-110, IG-430 and NBG-25 nuclear graphite, J. Nucl. Mater. 420 (2012) 141-158. https://doi.org/10.1016/j.jnucmat.2011.09.027.
Y.S. Lim, S.H. Chi, K.Y. Cho, Change of properties after oxidation of IG-11 graphite by air and CO₂ gas, J. Nucl. Mater. 374 (2008) 123-128. https://doi.org/10.101 6/j.jnucmat.2007.07.015.
M. Lou Dunzik-Gougar, T.E. Smith, Removal of carbon-14 from irradiated graphite, J. Nucl. Mater. 451 (2014) 328-335. https://doi.org/10.1016/j.jnucmat.2014.03.018.
J. Cleaver, S. Mccrory, T.E. Smith, M. Lou Dunzik-Gougar, Chemical Characterization and Removal of 14C from Irradiated Graphite -12010, WM2012 Conf. (2012) 1-15. https://pdfs.semanticscholar.org/5d 18/495a2d4 78cbfed2b9699f2bf8810d855a43 7. pdf (accessed Sep. 8, 2018).
T.E. Smith, S. McCrory, M. Lou Dunzik-Gougar, Limited oxidation of irradiated graphite waste to remove surface carbon-14, Nucl. Eng. Technol. 45 (2013) 211-218. https://doi.org/10.5516/NET.06.2012.025.
C.I. Contescu, R.W. Mee, P. Wang, A. V. Romanova, T.D. Burchell, Oxidation of PCEA nuclear graphite by low water concentrations in helium, J. Nucl. Mater. 453 (2014) 225-232. https://doi.org/10.101 6/j.jnucmat.2014.07.009.
D. Vulpius, K. Baginski, C. Fischer, B. Thomauske, Location and chemical bond of radionuclides in neutron-irradiated nuclear graphite, J. Nucl. Mater. 438 (2013) 163-177. https://doi.org/10.101 6/j.jnucmat.2013.02.027.
J. Fachinger, W. von Lensa, T. Podruhzina, Decontamination of nuclear graphite, Nucl. Eng. Des. 238 (2008) 3086-3091. https://doi.org/10.1016/j.nucengdes.2008.02.010.
W. von Lensa, D. Vulpius, H. Steinmetz, A.W. Banford, D. Bradbury, J.M. Graves, A.N.N. Jones, B. Grambow, L. Petit, G. Pina, D. Vulpius, A.W. Banford, Treatment and Disposal of irradiated Graphite and other Carbonaceous Waste, ATW- Int. J. Nucl. Power. 56 (2011) 263.
L. Payne, P.J. Heard, T.B. Scott, A study of the oxidation behaviour of pile grade A (PGA) nuclear graphite using thermogravimetric analysis (TGA), scanning electron microscopy (SEM) and x-ray tomography (XRT), PLoS One. 10 (2015) e0143041. https://doi.org/10.1371/journal.pone.0143041.
L.M. Apatiga, A. Castaneda-Miranda, C. Menchaca, V.M. Castano, Selective Oxidation of Graphite on Diamond Films Induced by UV Exposure, Inorg. Mater. 38 (2002) 31-33. https://doi.org/10.1023/A:1013695226044.
M. Le Guillou, N. Toulhoat, Y. Pipon, N. Moncoffre, H. Khodja, Deuterium migration in nuclear graphite: Consequences for the behavior of tritium in CO2-cooled reactors and for the decontamination of irradiated graphite waste, J. Nucl. Mater. 461 (2015) 72-77. https://doi.org/10.1016/J.JNUCMAT.2015.03.005.
J. Liu, C. Wang, L. Dong, T. Liang, Study on the Recycling of Nuclear Graphite after Micro-Oxidation, Nucl. Eng. Technol. 48 (2016) 182-188. https://doi.org/10.1016/j.net.2015.08.007.
A. Theodosiou, A.N. Jones, B.J. Marsden, Thermal oxidation of nuclear graphite: A large scale waste treatment option, PLoS One. 12 (2017) e0182860. https://doi.org/10.1371/journal.pone.0182860.
IAEA, Characterization, treatment and conditioning of radioactive graphite from decommissioning of nuclear reactors, Tecdoc 1521. (2006). https://doi.org/IAEA-TECDOC-1521.
A. V. Bushuev, Y.M. Verzilov, V.N. Zubarev, E. V. Petrova, T.B. Aleeva, I.M. Proshin, A.E. Kachanovskii, A.M. Dmitriev, E. V. Zakharova, S.I. Ushakov, A.G. Nikolaev, I.I. Baranov, Y.I. Kabanov, E.N. Kolobova, Experimental study of the radioactive contamination of graphite masonry in the commercial reactors at the Siberian Chemical Combine, At. Energy. 92 (2002) 514-522. https://doi.org/10.1023/A:1020226517989.
L. Tian, M. Wen, L. Li, J. Chen, Disintegration of graphite matrix from the simulative high temperature gas-cooled reactor fuel element by electrochemical method, Electrochim. Acta. 54 (2009) 7313-7317. https://doi.org/10.1016/j.electacta.2009.07.056.
T. Grebennikova, C.A. Sharrad, A.N. Jones, Decontamination of Irradiated Nuclear Graphite Using High Temperature Molten Salt-17447, in: WM2017 Conf. March 5 - 9, 2017, Phoenix, Arizona, USA, 2017. http://archive.wmsym.org/2017/pdfs/FinalPaper_17447_0131034757.pdf (accessed Mar. 1, 2020).
M. Mostafavi, M.J.J. Schmidt, B.J. Marsden, T.J. Marrow, Fracture behaviour of an anisotropic polygranular graphite (PGA), Mater. Sci. Eng. A. 558 (2012) 265-277. https://doi.org/10.1016/j.msea.2012.08.001.
J.E. Brocklehurst, R.G. Brown, K.E. Gilchrist, V.Y. Labaton, The effect of radiolytic oxidation on the physical properties of graphite, J. Nucl. Mater. 35 (1970) 183-194. https://doi.org/10.1016/0022-3115(70)90099-1.
J. V. Best, W.J. Stephen, A.J. Wickham, Radiolytic graphite oxidation, 1985. https://doi.org/10.1016/0149-1970(85)90002-2.
A.M.S. El Din, Molten salt electrolysis-I. Chlorine over-potential on carbon in LiCI-KCI eutectic, Electrochim. Acta. 4 (1961) 242-250. https://doi.org/10.1016/0013-4686(61)80020-0.
E. Gileadi, Electrode Kinetics for Chemists, Chemical Engineers and Materials Scientists, VCH, 1993. https://books.google.co.uk/books/about/Electrode_Kinetics_for_Chemists_Chemical.html?id =m9d9pkweaW4C&redir_esc=y (accessed Sep. 4, 2018).
E. Gileadi, E. Kirowa-Eisner, J. Penciner, Interfacial electrochemistry : an experimental approach, Addison-Wesley Pub. Co., Advanced Book Program, 1975. https://books.google.co.uk/books/about/Interfacial_electrochemistry.html?id=NAjwAAAAMA AJ&redir_esc=y (accessed Sep. 4, 2018).
Her Majesty’s Stationery Office, Review of radioactive waste management policy: final conclusions, C. 2919. (1995) 55. https://books.google.co.uk/books/about/Review_of_Radioactive_Waste_Management_P.ht ml?id=5X_SAAAACAAJ&redir_esc=y (accessed Jul. 16, 2018).
J. Simonet, H. Lund, Electrochemical behaviour of graphite cathodes in the presence of tetraalkylammonium cations, J. Electroanal. Chem. 75 (1977) 719-730. https://doi.org/10.1016/S0022-0728(77)80211-8.
M.. Rabah, N. Nassif, A.A.A. Azim, Electrochemical wear of graphite anodes during electrolysis of brine, Carbon N. Y. 29 (1991) 165-171. https://doi.org/10.1016/0008-6223(91)90066-R.
J.H. Entwisle, Consumption of graphite anodes in chlorine manufacture by brine electrolysis, J. Appl. Electrochem. 4 (1974) 293-303. https://doi.org/10.1007/BF00608971.
L.J.J. Janssen, The mechanism of the chlorine evolution on different types of graphite anodes during the electrolysis of an acidic NaCl solution, Electrochim. Acta. 19 (1974) 257-265. https://doi.org/10.1016/0013-4686(74)85076-0.
P.E. Fanning, M.A. Vannice, A drifts study of the formation of surface groups on carbon by oxidation, Carbon N. Y. 31 (1993) 721-730. https://doi.org/10.1016/0008-6223(93)90009-Y.
T.E. Smith, S. McCrory, M. Lou Dunzik-Gougar, Limited oxidation of irradiated graphite waste to remove surface carbon-14, Nucl. Eng. Technol. 45 (2013) 211-218. https://doi.org/10.5516/NET.06.2012.025.
R. Krishna, A.N. Jones, B.J. Marsden, Transmission electron microscopy, Raman and X-ray photoelectron spectroscopy studies on neutron irradiated polycrystalline graphite, Radiat. Phys. Chem. 107 (2015) 121-127. https://doi.org/10.1016/j.radphyschem.2014.10.005.
G.Z. Chen, D.J. Fray, Cathodic refining in molten salts: Removal of oxygen, sulfur and selenium from static and flowing molten copper, J. Appl. Electrochem. 31 (2001) 155-164. https://doi.org/10.1023/A:1004175605236.
W.A. Nystrom, Electrolytic Degradation and Electrode Structure, J. Electrochem. Soc. 116 (1969) 17-24. https://doi.org/10.1149/1.2411746.
P. Kumar, Chapter 5 - Electromigration in Metallic Materials and Its Role in Whiskering, in: Handb. Solid State Diffus., 2017: pp. 173-206. https://doi.org/10.1016/B978-0-12-804548-0.00005-0.
V.S. Bagotsky, Fundamentals of Electrochemistry: Second Ed., John Wiley & Sons, Inc., Hoboken, NJ, USA, 2005. https://doi.org/10.1002/047174199X.
R. Meirbekova, G.M. Haarberg, J. Thonstad, G. Saevarsdottir, Influence of phosphorus on current efficiency in aluminum electrolysis at different current densities, J. Electrochem. Soc. 164 (2017) E161-E165. https://doi.org/10.1149/2.0941707jes.
M. Kurata, T. Inoue, J. Serp, M. Ougier, J.P. Glatz, Electro-chemical reduction of MOX in LiCl, J. Nucl. Mater. 328 (2004) 97-102. https://doi.org/10.1016/j.jnucmat.2004.03.013.
J. Li, M. Lou Dunzik-Gouga, J. Wang, Recent advances in the treatment of irradiated graphite: A review, Ann. Nucl. Energy. 110 (2017) 140-147. https://doi.org/10.1016/j.anucene.2017.06.040.
D. Ancius, D. Ridikas, V. Remeikis, A. Plukis, R. Plukiene, M. Cometto, Evaluation of the activity of irradiated graphite in the Ignalina Nuclear Power Plant RBMK-1500 reactor, Nukleonika. 50 (2005) 113-120.
IAEA, Progress in Radioactive Graphite Waste Management, Tecdoc 1647. (2010) 20.
R.D. Shannon, Revised effective ionic radii and systematic studies of interatomic distances in halides and chalcogenides, Acta Crystallogr. Sect. A. 32 (1976) 751-767. https://doi.org/10.1107/S0567739476001551.
J. Park, S. Choi, S. Sohn, I.S. Hwang, Cyclic Voltammetry on Zr, Sn, Fe, Cr and Co in LiCI-KCI Salts at 500° C. for Electrorefining of Irradiated Zircaloy-4 Cladding, J. Electrochem. Soc. 164 (2017) D744-D751. https://doi.org/10.1149/2.1501712jes.
K.E. Johnson, J.R. Mackenzie, Samarium, Europium, and Ytterbium Electrode Potentials in LiCI-KCI Eutectic Melt, J. Electrochem. Soc. 116 (1969) 1697. https://doi.org/10.1149/1.2411665.
H. Kim, T. Lichtenstein, N.D. Smith, Electrochemical Separation of Barium ions from LiCl—KCl—BaCl2 Electrolyte Using Liquid Bi and Sb Electrodes, Meet. Abstr. MA2017-02 (2017) 975-975. http://ma.ecsdl.org/content/MA2017-02/19/975?related-urls=yes&legid=ecsmtgabs;MA2017-02/19/975 (accessed Jul. 15, 2018).
P. Bagri, M.F. Simpson, Determination of activity coefficient of lanthanum chloride in molten LiCI-KCI eutectic salt as a function of cesium chloride and lanthanum chloride concentrations using electromotive force measurements, J. Nucl. Mater. 482 (2016) 248-256. https://doi.org/10.1016/J.JNUCMAT.2016.10.006.
H.A. Laitinen, C.H. Liu, An Electromotive Force Series in Molten Lithium Chloride-Potassium Chloride Eutectic 1, J. Am. Chem. Soc. 80 (1958) 1015-1020. https://doi.org/10.1021 /ja01538a001.
J. Serp, M. Allibert, A. Le Terrier, R. Malmbeck, M. Ougier, J. Rebizant, J.-P. Glatz, Electroseparation of Actinides from Lanthanides on Solid Aluminum Electrode in LiCI-KCI Eutectic Melts, J. Electrochem. Soc. 152 (2005) C167. https://doi.org/10.1149/1.1859812.
M. Shaltry, S. Phongikaroon, M.F. Simpson, Ion exchange kinetics of fission products between molten salt and zeolite-A, Microporous Mesoporous Mater. 152 (2012) 185-189. https://doi.org/10.1016/j.micromeso.2011.11.035.
T. Grebennikova, C.A. Sharrad, A.N. Jones, Electrochemical decontamination of irradiated PGA graphite from corrosion and fission products in LiCl—KCl, (n.d.).
S. Brunauer, P.H. Emmett, E. Teller, Adsorption of Gases in Multimolecular Layers, J. Am. Chem. Soc. 60 (1938) 309-319. https://doi.org/10.1021/ja01269a023.
F. Rouquerol, J. (Jean) Rouquerol, K.S.W. Sing, Adsorption by powders and porous solids : principles, methodology, and applications, Academic Press, 1999.
G.E. Bacon, Unit-cell dimensions of graphite, Acta Crystallogr. 3 (1950) 137-139. https://doi.org/10.1 107/S03651 10X5000029X.
M.S. Seehra, A.S. Pavlovic, X-Ray diffraction, thermal expansion, electrical conductivity, and optical microscopy studies of coal-based graphites, Carbon N. Y. 31 (1993) 557-564. https://doi.org/10.1016/0008-6223(93)90109-N.
K.L. Jones, G.M. Laudone, G.P. Matthews, A multi-technique experimental and modelling study of the porous structure of IG-110 and IG-430 nuclear graphite, Carbon N. Y. 128 (2018) 1-11. https://doi.org/10.1016/j.carbon.2017.11.076.
B.T. Kelly, Radiation-Damage in Graphite and Its Relevance to Reactor Design, Prog. Nucl. Energy. 2 (1978) 219-269.
G. (Graham). Beamson, D. (David) Briggs, SurfaceSpectra Ltd., CasaXPS: Processing Software for XPS, AES, SIMS and More, (2000). http://www.casaxps.com/ (accessed Aug. 28, 2018).
J.F. Moulder, J. Chastain, Handbook of X-ray Photoelectron Spectroscopy: A Reference Book of Standard Spectra for Identification and Interpretation of XPS Data, Physical Electronics Division, Perkin-Elmer Corporation, 1992. https://books.google.co.uk/books?id=A_XGQgAACAAJ.
H. Estrade-Szwarckopf, XPS photoemission in carbonaceous materials: A “defect” peak beside the graphitic asymmetric peak, Carbon N. Y. 42 (2004) 1713-1721. https://doi.org/10.1016/j.carbon.2004.03.005.
Y. Zou, A.S. Walton, I.A. Kinloch, R.A.W. Dryfe, Investigation of the Differential Capacitance of Highly Ordered Pyrolytic Graphite as a Model Material of Graphene, Langmuir. 32 (2016) 11448-11455. https://doi.org/10.1021/acs.langmuir.6b02910.
W. Xie, L.T. Weng, K.M. Ng, C.K. Chan, C.M. Chan, Clean graphene surface through high temperature annealing, Carbon N. Y. 94 (2015) 740-748. https://doi.org/10.1016/j.carbon.2015.07.046.
D. Bouša, J. Luxa, V. Mazánek, O. Jankovský, D. Sedmidubský, K. Klímová, M. Pumera, Z. Sofer, Toward graphene chloride: chlorination of graphene and graphene oxide, RSC Adv. 6 (2016) 66884-66892. https://doi.org/10.1039/C6RA14845J.
P.-L. Girard-Lauriault, R. Illgen, J.-C. Ruiz, M.R. Wertheimer, W.E.S. Unger, Surface functionalization of graphite and carbon nanotubes by vacuum-ultraviolet photochemical reactions, Appl. Surf. Sci. 258 (2012) 8448-8454. https://doi.org/10.1016/J.APSUSC.2012.03.012.
J. Kane, C. Karthik, D.P. Butt, W.E. Windes, R. Ubic, Microstructural characterization and pore structure analysis of nuclear graphite, J. Nucl. Mater. 415 (2011) 189-197. https://doi.org/10.1016/j.jnucmat.2011.05.053.
I.M. Pickup, B. McEnaney, R.G. Cooke, Fracture processes in graphite and the effects of oxidation, Carbon N. Y. 24 (1986) 535-543. https://doi.org/10.1016/0008-6223(86)90142-9.
W.H. Huang, S.C. Tsai, C.W. Yang, J.J. Kai, The relationship between microstructure and oxidation effects of selected IG- and NBG-grade nuclear graphites, J. Nucl. Mater. 454 (2014) 149-158. https://doi.org/10.1016/j.jnucmat.2014.07.052.
M. Balden, K.U. Klages, W. Jacob, J. Roth, Oxidative erosion of graphite in air between 600 and 1000 K, J. Nucl. Mater. 341 (2005) 31-44. https://doi.org/10.1016/j.jnucmat.2005.01.006.
M.A. Banares-Munoz, L.V.F. Gonzalez, J.M.M. Llorenta, Adsorption isotherms of nitrogen and argon on an “agot” grade artificial nuclear graphite at 77 and 90 K, Carbon N. Y. 25 (1987) 603-608. https://doi.org/10.1016/0008-6223(87)90210-7.
R. Nightingale, Early use of nuclear graphite, (1962).
K.Y. Wen, T.J. Marrow, B.J. Marsden, The microstructure of nuclear graphite binders, Carbon N. Y. 46 (2008) 62-71. https://doi.org/10.1016/j.carbon.2007.10.025.
Sahimi Muhammad, Flow and Transport in Porous Media and Fractured Rock: From Classical Methods to Modern Approaches, Wiley-VCH, 2011. https://books.google.co.uk/books?hl=ru&lr=&id=0c7GbqfBv10C&oi=fnd&pg=PT12&ots=Uf41 7NFxXu&sig=xMNcD4VTrybQM3n3UVffdgUdeQg&redir-esc=y#v=onepage&q&f=false (accessed Aug. 15, 2018).
J.M. Dickinson, J.W. Shore, Observations concerning the determination of porosities in graphites, Carbon N. Y. 6 (1968) 937-941. https://doi.org/10.1016/0008-6223(68)90077-8.
Z. He, L. Gao, W. Qi, B. Zhang, X. Wang, J. Song, X. He, C. Zhang, H. Tang, H. Rohan, H. Xia, X. Zhou, Molten FLiNaK salt infiltration into degassed nuclear graphite under inert gas pressure, Carbon N. Y. 84 (2015) 511-518. https://doi.org/10.1016/j.carbon.2014.12.044.
W.-H. Huang, S.-C. Tsai, I.-C. Chiu, C.-H. Chen, J.-J. Kai, The oxidation effects of nuclear graphite during air-ingress accidents in HTGR, Nucl. Eng. Des. 271 (2014) 270-274. https://doi.org/10.1016/J.NUCENGDES.2013.11.047.
J.L. Wood, R.C. Bradt, P.L. Walker, Oxidation effects on toughness and slow crack growth in polycrystalline graphites, Carbon N. Y. 18 (1980) 179-189. https://doi.org/10.1016/0008-6223(80)90059-7.
C.I. Contescu, S. Azad, D. Miller, M.J. Lance, F.S. Baker, Practical aspects for characterizing air oxidation of graphite, J. Nucl. Mater. 381 (2008) 15-24. https://doi.org/10.1016/J.JNUCMAT.2008.07.020.
G. Zheng, P. Xu, K. Sridharan, T. Allen, Characterization of structural defects in nuclear graphite IG-110 and NBG-18, J. Nucl. Mater. 446 (2014) 193-199. https://doi.org/10.1016/j.jnucmat.2013.12.013.
C.I. Contescu, T. Guldan, P. Wang, T.D. Burchell, The effect of microstructure on air oxidation resistance of nuclear graphite, Carbon N. Y. 50 (2012) 3354-3366. https://doi.org/10.1016/j.carbon.2012.01.040.
P. Yu, S.E. Lowe, G.P. Simon, Y.L. Zhong, Electrochemical exfoliation of graphite and production of functional graphene, Curr. Opin. Colloid Interface Sci. 20 (2015) 329-338. https://doi.org/10.1016/j.cocis.2015.10.007.
G.M. Laudone, C.M. Gribble, G.P. Matthews, Characterisation of the porous structure of Gilsocarbon graphite using pycnometry, cyclic porosimetry and void-network modeling, Carbon N. Y. 73 (2014) 61-70. https://doi.org/10.1016/J.CARBON.2014.02.037.
I.A. Novoselova, S. V. Kuleshov, S. V. Volkov, V.N. Bykov, Electrochemical synthesis, morphological and structural characteristics of carbon nanomaterials produced in molten salts, Electrochim. Acta. 211 (2016) 343-355. https://doi.org/10.1016/J.ELECTACTA.2016.05.160.
G.Z. Chen, X. Fan, A. Luget, M.S.. Shaffer, D.J. Fray, A.H. Windle*, Electrolytic conversion of graphite to carbon nanotubes in fused salts, J. Electroanal. Chem. 446 (1998) 1-6. https://doi.org/10.1016/S0022-0728(97)00552-4.
W.K. Hsu, M. Terrones, J.P. Hare, H. Terrones, H.W. Kroto, D.R.M. Walton, Electrolytic formation of carbon nanostructures, Chem. Phys. Lett. 262 (1996) 161-166. https://doi.org/10.1016/0009-2614(96)01041-X.
C. Schwandt, A.T. Dimitrov, D.J. Fray, High-yield synthesis of multi-walled carbon nanotubes from graphite by molten salt electrolysis, Carbon N. Y. 50 (2012) 1311-1315. https://doi.org/10.1016/j.carbon.2011.10.054.
W. Yuan, Y. Zhou, Y. Li, C. Li, H. Peng, J. Zhang, Z. Liu, L. Dai, G. Shi, The edge- and basal-plane-specific electrochemistry of a single-layer graphene sheet, Sci. Rep. 3 (2013) 2248. https://doi.org/10.1038/srep02248.
N. Chen, R.T. Yang, Ab Initio Molecular Orbital Study of the Unified Mechanism and Pathways for Gas-Carbon Reactions †, J. Phys. Chem. A. 102 (1998) 6348-6356. https://doi.org/10.1021/jp981518g.
Z.H. Zhu, J. Finnerty, G.Q. Lu, R.T. Yang, A Comparative Study of Carbon Gasification with O 2 and CO 2 by Density Functional Theory Calculations, Energy & Fuels. 16 (2002) 1359-1368. https://doi.org/10.1021/ef0200020.
H.Y. Ryu, S.M. Jeong, Y.C. Kang, J.-G. Kim, Electrochemical Carbon Formation from a Graphite Anode in Li2O/LiCl Molten Salt, Asian J. Chem. 25 (2013) 7019-7022. https://doi.org/10.14233/ajchem.2013.08.
M. Bolmont, S. Cahen, M. Fauchard, R. Guillot, G. Medjahdi, P. Berger, G. Lamura, P. Lagrange, C. Herold, LiCl—KCl eutectic molten salt as an original and efficient medium to intercalate metals into graphite: Case of europium, Carbon N. Y. 133 (2018) 379-383. https://doi.org/10.1016/J.CARBON.2018.03.015.
G.B. Engle, B.T. Kelly, Radiation damage of graphite in fission and fusion reactor systems, J. Nucl. Mater. 122 (1984) 122-129. https://doi.org/10.1016/0022-3115(84)90582-8.
R. Krishna, J. Wade, A.N. Jones, M. Lasithiotakis, P.M. Mummery, B.J. Marsden, An understanding of lattice strain, defects and disorder in nuclear graphite, Carbon N. Y. 124 (2017) 314-333. https://doi.org/10.1016/j.carbon.2017.08.070.
Q. Xu, C. Schwandt, G.Z. Chen, D.J. Fray, Electrochemical investigation of lithium intercalation into graphite from molten lithium chloride, J. Electroanal. Chem. 530 (2002) 16-22.
R. Hagiwara, M. Ito, Y. Ito, Graphite intercalation compounds of lanthanide metals prepared in molten chlorides, Carbon N. Y. 34 (1996) 1591-1593. https://doi.org/10.1016/S0008-6223(96)00109-1.
V. Bernardet, S. Gomes, S. Delpeux, M. Dubois, K. Guerin, D. Avignant, G. Renaudin, L. Duclaux, Protection of nuclear graphite toward fluoride molten salt by glassy carbon deposit, J. Nucl. Mater. 384 (2009) 292-302. https://doi.org/10.1016/j.jnucmat.2008.11.032.
R.W. Henson, W.N. Reynolds, Lattice parameter changes in irradiated graphite, Carbon N. Y. 3 (1965) 277-287. https://doi.org/10.1016/0008-6223(65)90062-X.
R.W. Henson, A.J. Perks, J.H.W. Simmons, Lattice parameter and dimensional changes in graphite irradiated between 300 and 1350° C., Carbon N. Y. 6 (1968) 789-806. https://doi.org/10.1016/0008-6223(68)90065-1.
A. Kelly, K.M. Knowles, Point Defects, in: Crystallogr. Cryst. Defects, John Wiley & Sons, Ltd, Chichester, UK, 2012: pp. 305-334. https://doi.org/10.1002/9781119961468.ch10.
S. Ishiyama, T.D. Burchell, J.P. Strizak, M. Eto, The effect of high fluence neutron irradiation on the properties of a fine-grained isotropic nuclear graphite, J. Nucl. Mater. 230 (1996) 1-7. https://doi.org/10.1016/0022-3115(96)00005-0.
L. Mcdermott, Characterisation and Chemical Treatment of Irradiated UK Graphite Waste, PhD dissertation, The University of Manchester, 2011.
R.N. Worth, Thermal Treatment Of Oldbury Magnox Reactor Irradiated Graphite, PhD dissertation, The University of Manchester, 2015.
S.L. Kanashenko, A.E. Gorodetsky, V.. N. Chemikov, A. V. Markin, A.P. Zakharov, B.L. Doyle, W.R. Wampler, Hydrogen adsorption on and solubility in graphites, J. Nucl. Mater. 233-237 (1996) 1207-1212. https://doi.org/10.1016/S0022-3115(96)00067-0.
H. Atsumi, K. Tauchi, Hydrogen absorption and transport in graphite materials, J. Alloys Compd. 356-357 (2003) 705-709. https://doi.org/10.1016/S0925-8388(03)00290-1.
H. Atsumi, T. Tanabe, T. Shikama, Hydrogen behavior in carbon and graphite before and after neutron irradiation - Trapping, diffusion and the simulation of bulk retention, in: J. Nucl. Mater., 2011: pp. 633-636. https://doi.org/10.1016/j.jnucmat.2010.12.100.
M. Le Guillou, N. Toulhoat, Y. Pipon, N. Moncoffre, H. Khodja, Deuterium migration in nuclear graphite: Consequences for the behavior of tritium in CG2-cooled reactors and for the decontamination of irradiated graphite waste, J. Nucl. Mater. 461 (2015) 72-77. https://doi.org/10.1016/j.jnucmat.2015.03.005.
K. Katayama, T. Takeishi, Y. Manabe, H. Nagase, M. Nishikawa, N. Miya, Tritium release behavior from the graphite tiles used at the dome unit of the W-shaped divertor region in JT-60U, J. Nucl. Mater. 340 (2005) 83-92. https://doi.org/10.1016/j.jnucmat.2004.11.005.
E. Narkunas, A. Smaizys, P. Poskas, ANALYSIS OF NITROGEN IMPURITY IMPACT ON 14 C GENERATION IN RBMK-1500 REACTOR GRAPHITE, n.d. http://www.carbowaste.eu/Iw_resource/datapool/₋pages/pdp_10/Paper RBMK-Graphite-Narkunas_full_mod.pdf (accessed Sep. 13, 2018).
B.J. Marsden, K.L. Hopkinson, A.J. Wickham, The Chemical Form of Carbon-14 within Graphite. Report SA/RJCB/RD03612001/R01 Issue 4. A Serco Assurance Report for NIREX., 2002.
P.L. Walker, Jr., J.F. Rusinko, L.G. Austin, Gas Reactions of Carbon, Adv. Catal. 11 (1959) 133-221. https://doi.org/10.1016/S0360-0564(08)60418-6.

1. A method of electrochemically decontaminating irradiated nuclear graphite, the method comprising:
immersing irradiated nuclear graphite in a molten salt electrolyte, wherein the molten salt comprises one or more alkali metal halide salts, alkaline earth metal halide salts, or combinations thereof; and
subjecting the irradiated nuclear graphite to an electrochemical treatment comprising one or more electrochemical cycles, wherein each electrochemical cycle comprises exposing the irradiated nuclear graphite to an oxidising and reducing electric potential.

2. The method of claim 1, wherein the irradiated nuclear graphite is exposed to a current density of from 0.001 to 50 mA/cm², alternating between oxidising and reducing potentials.

3. The method of claim 1, wherein the irradiated nuclear graphite is exposed to a current density of 0.01 to 20 mA/cm², alternating between oxidising and reducing potentials.

4. The method of claim 1, wherein the irradiated nuclear graphite is exposed to a current density of 0.01 to 0.5 mA/cm², alternating between oxidising and reducing potentials.

5. The method of claim 1, wherein the irradiated nuclear graphite has a specific surface area of from 0.01 m²/g to 10 m²/g.

6. The method of claim 1, wherein the irradiated nuclear graphite has a density of at least 0.8 g/cm³.

7. The method of claim 1, wherein the electrochemical treatment comprises a plurality of electrochemical cycles.

8. The method of claim 1, wherein the duration of each electrochemical cycle is from 0.1 ns to 10 s.

9. The method of claim 1, wherein the duration of each electrochemical cycle is from 10 seconds to 10 hours.

10. The method of claim 1, wherein the total duration of the electrochemical treatment is up to 72 hours.

11. The method of claim 1, wherein the molten salt is selected from one or more alkali metal chlorides, alkali metal fluorides, alkaline earth metal chlorides and alkali earth metal fluorides.

12. The method of claim 1, wherein the molten salt comprises a mixture of one or more alkali metal halide salts and/or one or more alkaline earth metal halide salts.

13. The method of claim 1, wherein the molten salt comprises one or more of LiCl, NaCl, KCl, RbCl, CsCl, BeCl₂, MgCl₂, CaCl₂, SrCl₂, BaCl₂, LiF, NaF, KF, RbF, CsF, BeF₂, MgF₂, CaF₂, SrF₂ and BaF₂.

14. The method of claim 1, wherein the molten salt further comprises a metal oxide.

15. The method of claim 1, wherein the molten salt is heated to a temperature of from 350° C. to 700° C.

16. The method of claim 1, wherein the method is performed in an atmosphere in which the level of oxygen is controlled.

17. The method of claim 1, wherein the progress of the method is monitored, e.g. by quantitative gas analysis.

18. The method of claim 1, wherein the progress of the method is monitored by gamma spectroscopy.

19. The method of claim 1, wherein the method is performed in an inert atmosphere.

20. The method of claim 1, further comprising the removal of radionuclides deposited on electrodes and/or present in the molten salt.
